(19) United States
(12) Patent Application Publication
(10) Pub. No.: US 2008/0133240 A1
(43) Pub. Date: Jun. 5, 2008

(54) Spoken dialog system, terminal device, speech information management device and recording medium with program recorded thereon

(75) Inventors: Ryosuke Miyata, Kawasaki (JP); Toshiyuki Fukuoka, Kawasaki (JP); Kyouko Okuyama, Kawasaki (JP); Eiji Kitagawa, Kawasaki (JP); Takuro Ikeda, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/902,490

(22) Filed: Sep. 21, 2007

(30) Foreign Application Priority Data
Nov. 30, 2006 (JP) 2006-323978

(51) Int. Cl. G10L 15/02

(52) U.S. Cl. 704/257; 704/E15.004

(57) ABSTRACT

A spoken dialog system includes: a communication processing section capable of communicating with a terminal device that stores user data; and at least one of a speech synthesis section that generates synthesized speech and a speech recognition section that recognizes input speech. The communication processing section acquires from the terminal device at least one information of reading information and grammatical information, the reading information containing prosodic information on an item value of at least one item of the user data and the grammatical information indicating one or a plurality of recognition grammars on an item value of at least one item of the user data. The speech synthesis section generates the synthesized speech using the reading information acquired by the communication processing section, and the speech recognition section recognizes the input speech using the grammatical information acquired by the communication processing section.

### BACKGROUND OF THE INVENTION

1. Field of the Invention

The present invention relates to a spoken dialog system capable of communicating with a terminal device that stores user data and is provided with at least one of a speech synthesis section that generates synthesized speech and a speech recognition section that recognizes input speech, and also relates to a terminal device, a speech information management device as well as a recording medium with a program recorded thereon.

2. Description of Related Art

In recent years, car navigation systems (spoken dialog systems) that provide a driver of a mobile device such as a car with navigation information concerning transportation such as positional information and traffic information have become widely available. In particular, among them, a car navigation system provided with a speech interactive function has become popular recently. A terminal device such as a mobile phone or a music player is connected with such a car navigation system provided with a speech interactive function, whereby a driver can have a conversation without holding a mobile phone by hand (hand-free conversation) or reproduce a tune without operating a music player by hand (see for example JPH05(1993)-92741A or JP2001-95646A).

Meanwhile, a mobile phone stores user data such as schedule and names in a telephone directory. In general, such user data in a mobile phone includes the reading of Chinese characters represented in kana. For instance, when a mobile phone stores user data of [symbol] “ya-ma-da ta-ro-u” as their kana also is stored for it. When such a mobile phone is connected with a car navigation system, the car navigation system can generate synthesized speech or recognize input speech using the kana. When the mobile phone receives an incoming call, for example, the car navigation system reads aloud a name of the caller by using kana. Also, when a driver utters a name of a party with whom the driver wants to talk, the car navigation system recognizes this utterance by using kana and instructs the mobile phone to originate a call to that party.

A music player also stores user data such as tune names and artist names. In general, such user data in a music player does not include kana unlikely to a mobile phone. Therefore, a car navigation system is provided with a speech information database that stores reading information including prosodic information on user data and grammatical information indicating grammar for recognizing user data. Thereby, when a music player is connected with such a car navigation system, this car navigation system can generate synthesized speech or recognize input speech by using the speech information database provided therein. For instance, when the music player reproduces a tune, the car navigation system reads aloud the tune name to be reproduced with synthesized speech by using the reading information. Also, when a driver utters a tune name that the driver wants to reproduce, the car navigation system recognizes this utterance by using the grammatical information and instructs the music player to reproduce that tune.

However, in the case where synthesized speech is generated using kana or input speech is recognized using kana, the following problems occur.

That is to say, since kana does not contain reading information including prosodic information on user data, the synthesized speech generated using kana might be unnatural in prosody such as intonation and breaks in speech. Further, kana simply shows how to read the user data, and therefore if a driver utters the user data using other than the formal designation, e.g., using an abbreviation or a commonly used name, such utterance cannot be recognized.

Meanwhile, when synthesized speech is generated using the reading information or input speech is recognized using the grammatical information that is stored in a speech information database provided in a car navigation system, the following another problem will occur instead of the above-stated problems.

That is to say, since the speech information database has to store all possible reading information and grammatical information on user data that may be stored in a music player or a mobile phone, the amount of information to be stored in the speech information database will be enormous. Furthermore, since the car navigation system has to include retrieval means for extracting desired reading information and grammatical information from such a speech information database with the enormous amount of information, the cost of the car navigation system will increase.

### SUMMARY OF THE INVENTION

Therefore, with the foregoing in mind, it is an object of the present invention to provide a spoken dialog system, a terminal device, a speech information management device and a recording medium with a program recorded thereon, by which natural synthesized speech can be generated without increasing the cost of the spoken dialog system, and even when utterance is conducted in a plurality of ways, such utterance can be recognized.

In order to attain the above-mentioned object, a spoken dialog system of the present invention includes: a communication processing section capable of communicating with a terminal device that stores user data; and at least one of a speech synthesis section that generates synthesized speech and a speech recognition section that recognizes input speech. In this spoken dialog system, the communication processing section acquires from the terminal device at least one information of reading information and grammatical information, the reading information containing prosodic information on an item value of at least one item of the user data and the grammatical information indicating one or a plurality of recognition grammars on an item value of at least one item of the user data. The speech synthesis section generates the synthesized speech using the reading information acquired by the communication processing section. The speech recognition section recognizes the input speech using the grammatical information acquired by the communication processing section.

According to the spoken dialog system of the present invention, the communication processing section acquires from the terminal device at least one information of reading information and grammatical information, the reading information containing prosodic information on an item value of at least one item of the user data and the grammatical information indicating one or a plurality of recognition grammars on an item value of at least one item of the user data. The speech synthesis section generates the synthesized speech using the reading information acquired by the communication processing section. The speech recognition section recognizes the input speech using the grammatical information acquired by the communication processing section. With this configuration, even without a speech information database and retrieval means in the spoken dialog system that are required in the above-stated conventional configuration, the speech synthesis section can generate synthesized speech using reading information containing prosodic information, and the speech recognition section can recognize input speech using grammatical information indicating recognition grammar. Therefore, naturally synthesized speech can be generated and input speech can be recognized without an increase of the cost of the spoken dialog system. Herein, the grammatical information shows one or a plurality of recognition grammars for an item value of at least one item of the user data. Thus, even if there are a plurality of ways to speak concerning the item value of at least one item of the user data, the utterance (input speech) conducted in the plurality of ways can be recognized, as long as the recognition grammars cover such a plurality of ways of speaking.

The user data is data of a terminal device, e.g., about a telephone directory, schedule or a tune.

The prosodic information is information concerning an accent, intonation, rhythm, pose, speed, stress and the like.

In order to attain the above-mentioned object, a terminal device of the present invention includes: an interface section capable of communicating with a spoken dialog system having at least one function of a function to generate synthesized speech and a function to recognize input speech; and a data storage section that stores user data. In this terminal device, the data storage section further stores at least one information of reading information and grammatical information, the reading information containing prosodic information on an item value of at least one item of the user data and being used for generating the synthesized speech, and the grammatical information indicating one or a plurality of recognition grammars on an item value of at least one item of the user data and being used for recognizing the input speech. The terminal device further includes a control section that detects an event of the terminal device or an event from the spoken dialog system, and extracts at least one information of the reading information and the grammatical information stored in the data storage section based on the detected event. The interface section transmits the at least one information of the reading information and the grammatical information extracted by the control section to the spoken dialog system.

According to the terminal device of the present invention, the control section detects an event of the terminal device or an event from the spoken dialog system, and extracts at least one information of the reading information and the grammatical information stored in the data storage section based on the detected event. The interface section transmits the at least one information of the reading information and the grammatical information extracted by the control section to the spoken dialog system. With this configuration, even without a speech information database and retrieval means in the spoken dialog system that are required in the above-stated conventional configuration, synthesized speech can be generated using reading information containing prosodic information, and input speech can be recognized using grammatical information indicating recognition grammar. Therefore, naturally synthesized speech can be generated and input speech can be recognized without an increase of the cost of the spoken dialog system. Herein, the grammatical information shows one or a plurality of recognition grammars for an item value of at least one item of the user data. Thus, even if there are a plurality of ways to speak concerning the item value of at least one item of the user data, the utterance (input speech) conducted in the plurality of ways can be recognized, as long as the recognition grammars cover such a plurality of ways of speaking.

In order to attain the above-mentioned object, a dialogue control system of the present invention includes: a terminal device including a data storage section that stores user data; and a spoken dialog system including at least one of a speech synthesis section that generates synthesized speech and a speech recognition section that recognizes input speech, the terminal device being capable of communicating with the spoken dialog system. In this dialogue control system, the data storage section further stores at least one information of reading information and grammatical information, the reading information containing prosodic information on an item value of at least one item of the user data and being used for generating the synthesized speech, and the grammatical information indicating one or a plurality of recognition grammars on an item value of at least one item of the user data and being used for recognizing the input speech. The terminal device further includes: a control section that detects an event of the terminal device or an event from the spoken dialog system and extracts at least one information of the reading information and the grammatical information stored in the data storage section based on the detected event, and an interface section that transmits the at least one information of the reading information and the grammatical information extracted by the control section to the spoken dialog system. The spoken dialog system further includes: a communication processing section that acquires the at least one information of the reading information and the grammatical information transmitted by the interface section. The speech synthesis section generates the synthesized speech using the reading information acquired by the communication processing section, and the speech recognition section recognizes the input speech using the grammatical information acquired by the communication processing section.

According to the dialogue control system of the present invention, the control section detects an event of the terminal device or an event from the spoken dialog system and extracts at least one information of the reading information and the grammatical information stored in the data storage section based on the detected event. The interface section transmits the at least one information of the reading information and the grammatical information extracted by the control section to the spoken dialog system. The communication processing section acquires the at least one of the reading information and the grammatical information transmitted by the interface section. The speech synthesis section generates the synthesized speech using the reading information acquired by the communication processing section. The speech recognition section recognizes the input speech using the grammatical information acquired by the communication processing section. With this configuration, even without a speech information database and retrieval means in the spoken dialog system that are required in the above-stated conventional configuration, the speech synthesis section can generate synthesized speech using reading information containing prosodic information, and the speech recognition section can recognize input speech using grammatical information indicating recognition grammar. Therefore, naturally synthesized speech can be generated and input speech can be recognized without an increase of the cost of the spoken dialog system. Herein, the grammatical information shows one or a plurality of recognition grammars for an item value of at least one item of the user data. Thus, even if there are a plurality of ways to speak concerning the item value of at least one item of the user data, the utterance (input speech) conducted in the plurality of ways can be recognized, as long as the recognition grammars cover such a plurality of ways of speaking.

In order to attain the above-mentioned object, a speech information management device of the present invention includes a data transmission section capable of communicating with a terminal device. The speech information management device further includes: a data management section that detects an event of the speech information management device or an event from the terminal device and extracts user data from a user data storage section provided in the speech information management device or the terminal device based on the detected event; a speech information database that stores at least one information of reading information and grammatical information, the reading information containing prosodic information on an item value of the user data and being used for generating synthesized speech and the grammatical information indicating one or a plurality of recognition grammars on an item value of the user data and being used for recognizing input speech; and a data extraction section that extracts at least one information of the reading information and the grammatical information stored in the speech information database based on an item value of the user data extracted by the data management section. The data management section associates the item value of the user data with the at least one information of the reading information and the grammatical information extracted by the data extraction section to generate speech data, and the data transmission section transmits the speech data generated by the data management section to the terminal device.

According to the speech information management device of the present invention, the data management section detects an event of the speech information management device or an event from the terminal device, and extracts user data from a user data storage section based on the detected event. The data extraction section extracts at least one information of the reading information and the grammatical information stored in the speech information database based on an item value of the user data extracted by the data management section. The data management section associates the item value of the user data with the at least one information of the reading information and the grammatical information extracted by the data extraction section to generate speech data. Thereby, it is possible for the data transmission section to transmit the speech data generated by the data management section to the terminal device. Thus, the terminal device stores at least one information of the reading information and the grammatical information.

In the speech information management device of the present invention, preferably, the data extraction section extracts at least one information of reading information and grammatical information on a place stored in the speech information database based on an item value of address of the user data.

According to the above-stated configuration, the data extraction section extracts at least one information of reading information and grammatical information on a place stored in the speech information database based on an item value of address of the user data. With this configuration, even in the case where places in the user data have the same notation but are different in reading information and grammatical information, the data extraction section can extract desired reading information and grammatical information.

In the speech information management device of the present invention, preferably, the data extraction section extracts at least one information of reading information and grammatical information on a place stored in the speech information database based on item values of latitude and longitude of the user data.

According to the above-stated configuration, the data extraction section extracts at least one information of reading information and grammatical information on a place stored in the speech information database based on item values of latitude and longitude of the user data. With this configuration, even in the case where places in the user data have the same notation but are different in reading information and grammatical information, the data extraction section can extract desired reading information and grammatical information.

Preferably, the speech information management device of the present invention further includes: a plurality of speech information databases, each containing the reading information and the grammatical information, at least one of which is different in type of information among the plurality of speech information databases; and a selection section that selects one of the plurality of speech information databases based on a type of the user data extracted by the data management section.

With this configuration, the speech information management device includes a plurality of speech information databases containing reading information and grammatical information, at least one of which is different in types among the databases. The selection section selects one of the speech information databases based on the type of the user data extracted by the data management section. Thereby, it is possible for the user of the speech information management device to classify the speech information databases each containing different type of data such as person's names, place names, schedule or tunes, and therefore it is possible to manage the speech information databases easily.

Preferably, the speech information management device of the present invention further includes a communication section capable of communicating with a server device. The server device preferably includes a speech information database that stores at least one information of the reading information and the grammatical information, and the selection section preferably selects the speech information database provided in the server device based on a type of the user data extracted by the data management section.

According to the above-stated configuration, the selection section selects the speech information database provided in the server device based on the type of the user data extracted by the data management section. Thereby, it is possible for the data management section to associate the user data with at least one of the reading information and the grammatical information stored in the speech information database provided in the server device to generate speech data.

In order to attain the above-mentioned object, a recording medium of the present invention has stored thereon a program that makes a computer execute the following steps of: a communication step enabling communication with a terminal device that stores user data; and at least one of a speech synthesis step of generating synthesized speech and a speech recognition step of recognizing input speech. The communication step makes the computer execute a step of acquiring at least one information of reading information and grammatical information, the reading information containing prosodic information on an item value of at least one item of the user data and the grammatical information indicating one or a plurality of recognition grammars on an item value of at least one item of the user data. The speech synthesis step makes the computer execute the step of generating the synthesized speech using the reading information acquired in the communication step. The speech recognition step makes the computer execute the step of recognizing the input speech using the grammatical information acquired in the communication step.

In order to attain the above-mentioned object, a recording medium of the present invention has stored thereon a program that makes a computer provided with a data storage section that stores user data execute an interface step enabling communication with a spoken dialog system having at least one function of a function to generate synthesized speech and a function to recognize input speech. The computer is accessible to the data storage section that further stores at least one information of reading information and grammatical information, the reading information containing prosodic information on an item value of at least one item of the user data and being used for generating the synthesized speech, and the grammatical information indicating one or a plurality of recognition grammars on an item value of at least one item of the user data and being used for recognizing the input speech. The program further makes the computer execute a control step of detecting an event of the computer or an event from the spoken dialog system and extracting at least one information of the reading information and the grammatical information stored in the data storage section based on the detected event. The interface step further makes the computer execute a step of transmitting the at least one of the reading information and the grammatical information extracted in the control step to the spoken dialog system.

In order to attain the above-mentioned object, a recording medium of the present invention has stored thereon a program that makes a computer execute a data transmission step enabling communication with a terminal device, the computer being provided with a speech information database that stores at least one information of reading information and grammatical information, the reading information containing prosodic information on an item value of user data and being used for generating synthesized speech, and the grammatical information indicating one or a plurality of recognition grammars on an item value of the user data and being used for recognizing input speech. The program further makes the computer execute the following steps of: a data management step of detecting an event of the computer or an event from the terminal device and extracting user data from a user data storage section provided in the computer or the terminal device based on the detected event; and a data extraction step of extracting at least one information of the reading information and the grammatical information stored in the speech information database based on an item value of the user data extracted in the data management step. The data management step makes the computer execute a step of associating the item value of the user data with the at least one information of the reading information and the grammatical information extracted in the data extraction step to generate speech data. The data transmission step further makes the computer execute a step of transmitting the speech data generated in the data management step to the terminal device.

Note here that the recording media having stored thereon programs of the present invention has similar effects to those of the above-stated spoken dialog system, terminal device and speech information management device.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram schematically showing the configuration of a dialogue control system according to Embodiment 1 of the present invention.

FIG. 2 shows an exemplary data configuration of a data storage section of a terminal device in the above-stated dialogue control system.

FIG. 3 shows exemplary templates used by a dialogue control section of a spoken dialog system in the above-stated dialogue control system.

FIG. 4 is a flowchart showing an exemplary process in which the spoken dialog system acquires user data and reading information from a terminal device.

FIG. 5 is a flowchart showing an exemplary process in which the spoken dialog system acquires user data and grammatical information from a terminal device.

FIG. 6 shows a first modification of the data configuration of the above-stated data storage section.

FIG. 7 shows a first modification of the templates used by the above-stated dialogue control section.

FIG. 8 shows a second modification of the data configuration of the above-stated data storage section.

FIG. 9 shows a second modification of the templates used by the above-stated dialogue control section.

FIG. 10 is a block diagram schematically showing the configuration of a dialogue control system according to Embodiment 2 of the present invention.

FIG. 11 shows an exemplary data configuration of a user data storage section of a speech information management device in the above-stated dialogue control system.

FIG. 12 shows an exemplary data configuration of the speech information database in the above-stated speech information management device.

FIG. 13 shows an exemplary data configuration of the above-stated speech information database.

FIG. 14 shows an exemplary data configuration of the above-stated speech information database.

FIG. 15 is a flowchart showing an exemplary process of the terminal device to acquire user data, reading information and grammatical information from the speech information management device.

FIG. 16 shows a modification example of the data configuration of the above-stated user data storage section.

FIG. 17 shows a modification example of the data configuration of the above-stated speech information database.

FIG. 18 is a block diagram schematically showing the configuration of a dialogue control system according to Embodiment 3 of the present invention.

FIG. 19 is a block diagram schematically showing the configuration of a dialogue control system according to Embodiment 4 of the present invention.

### DETAILED DESCRIPTION OF THE INVENTION

The following describes embodiments of the present invention more specifically, with reference to the drawings.

### Embodiment 1

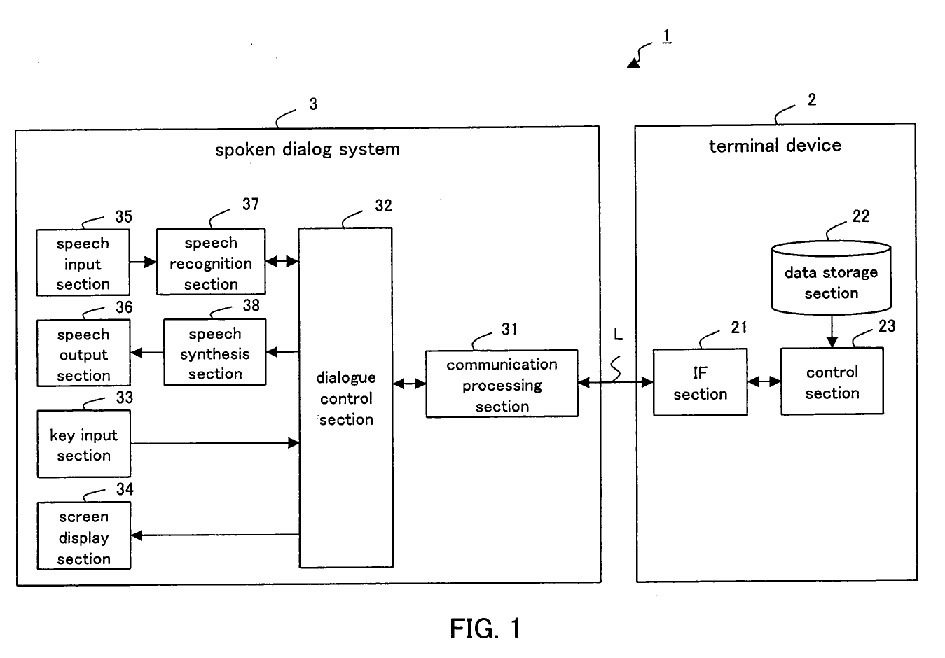

FIG. 1 is a block diagram schematically showing the configuration of a dialogue control system 1 according to the present embodiment. That is, the dialogue control system 1 according to the present embodiment includes a terminal device 2 and a spoken dialog system 3. The terminal device 2 may be a mobile terminal such as a mobile phone, a personal handyphone system (PHS), a personal digital assistance (PDA) or a music player. The spoken dialog system 3 may be a car navigation system, a personal computer or the like. The terminal device 2 and the spoken dialog system 3 are connected with each other via a cable L. Note here that the terminal device 2 and the spoken dialog system 3 may be accessible from each other by radio. Although FIG. 1 shows one terminal device 2 and one spoken dialog system 3 for the simplification of the description, terminal devices 2 and spoken dialog systems 3 in any number may be used to configure the dialogue control system 1. Alternatively, a plurality of terminal devices 2 may be connected with one spoken dialog system 3.

As for the present embodiment, the following exemplifies the case where the terminal device 2 is a mobile phone and the spoken dialog system 3 is a car navigation system to be installed in a vehicle.

(Configuration of Terminal Device)

The terminal device 2 includes an interface section (in the drawing, IF section) 21, a data storage section 22 and a control section 23.

The interface section 21 is an interface between the spoken dialog system 3 and the control section 23. More specifically, the interface section 21 converts the data to be transmitted to the spoken dialog system 3 into data suitable to communication, and converts the data from the spoken dialog system 3 into data suitable to internal processing.

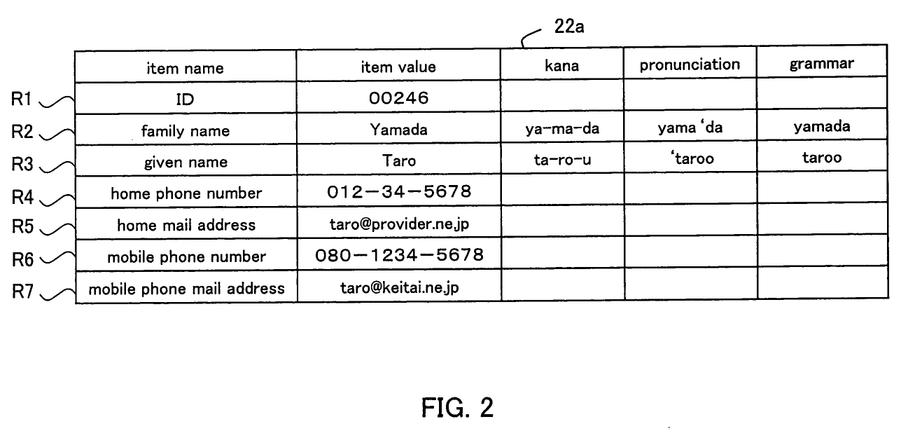

The data storage section 22 stores user data. The data storage section 22 further stores reading information and grammatical information, where the reading information contains prosodic information on an item value of at least one item of the user data and the grammatical information shows one or a plurality of recognition grammars for an item value of at least one item of the user data. FIG. 2 shows an exemplary data configuration of the data storage section 22. As shown in FIG. 2, the data storage section 22 stores item names, item values, kana, pronunciation and grammar as entry 22a. The item name shows a designation of an item. The item value shows the content corresponding to the item name. The kana shows how to read the item value. The pronunciation shows an accent of the item value. The grammar shows a recognition grammar for the item value. Note here that in the present embodiment user data refers to the above-stated item value, and the reading information refers to the above-stated pronunciation. Herein, the reading information may contain other prosodic information such as intonation, rhythm, pose, speed and stress in addition to the above-stated pronunciation. The grammatical information refers to the above-stated grammar.

As shown in FIG. 2, in the first line R1 of the entry 22a, the item name “ID” and the item value “00246” are stored. The “ID” is an identification code for uniquely identifying the entry 22a. In the second line R2, the item name “family name”, the item value “Yamada”, the kana “ya-ma-da”, the pronunciation “yama'da” and the grammar “yamada” are stored. In the third line R3, the item name “given name”, the item value “Taro”, the kana “ta-ro-u”, the pronunciation “'taroo” and the grammar “taroo” are stored. Herein, the mark ' in the pronunciation is an accent mark showing a portion to be pronounced with a higher pitch. A plurality of ways of pronunciation may be stored for an item value of one item. In the fourth line R4, the item name “home phone number” and the item value “012-34-5678” are stored. In the fifth line R5, the item name “home mail address” and the item value “taro@provider.ne.jp” are stored. In the sixth line R6, the item name “mobile phone number” and the item value “080-1234-5678” are stored. In the seventh line R7, the item name “mobile phone mail address” and the item value “taro@keitai.ne.jp” are stored. That is, the data storage section 22 stores user data in a telephone directory of the terminal device 2, which is just an example.

When the control section 23 detects an event of the terminal device 2 or an event from the spoken dialog system 3, the control section 23 extracts user data stored in the data storage section 22 in accordance with a predetermined extraction rule. Further, when the control section 23 detects an event of the terminal device 2 or an event from the spoken dialog system 3, the control section 23 extracts at least one information of the reading information and the grammatical information stored in the data storage section 22 in accordance with a predetermined extraction rule. Herein, the extraction rule may be a rule for extracting all reading information and grammatical information stored as entry, or a rule for extracting a predetermined reading information and grammatical information. In other words, the extraction rule may be any rule. The control section 23 outputs the extracted user data to the interface section 21. The control section 23 further outputs the extracted at least one information of the reading information and grammatical information to the interface section 21. The interface section 21 transmits the user data output from the control section 23 to the spoken dialog system 3. The interface section 21 further transmits the at least one information of the reading information and the grammatical information output from the control section 23 to the spoken dialog system 3.

For example, when the terminal device 2 receives an incoming call from a caller, the control section 23 extracts user data and the reading information of this user data stored in the data storage section 22 in accordance with a predetermined extraction rule. It is assumed that the extraction rule in this case is a rule for extracting reading information on “family name” and “given name” of the user data. More specifically, the control section 23 extracts the user data “Yamada” and “Taro” and their reading information “yama'da” and “'taroo” stored in the data storage section 22 based on the telephone number “012-34-5678” of the caller indicated by caller data. The control section 23 outputs the extracted information to the interface section 21. The interface section 21 transmits the user data “Yamada” and “Taro” and their reading information “yama'da” and “'taroo” output from the control section 23 to the spoken dialog system 3. Thereby, the spoken dialog system 3 can read aloud the name of the caller who originated the call to the terminal device 2 with synthesized speech in a natural prosodic manner like “yama'da” “'taroo”.

As another example, when a request is made from the spoken dialog system 3 for acquiring grammatical information, the control section 23 extracts user data and grammatical information of this user data stored in the data storage section 22 in accordance with a predetermined extraction rule. It is assumed that the extraction rule in this case is a rule for extracting grammatical information on “family name” and “given name” of the user data. More specifically, the control section 23 extracts the user data “Yamada” and “Taro” and their grammatical information “yamada” and “taroo” stored in the data storage section 22 based on the request from the spoken dialog system 3. The control section 23 outputs the extracted information to the interface section 21. The interface section 21 transmits the user data “Yamada” and “Taro” and their grammatical information “yamada” and “taroo” output from the control section 23 to the spoken dialog system 3. Thereby, when a user utters “yamadataroo”, for example, the spoken dialog system 3 can recognize this utterance and instruct the terminal device 2 to originate a call to a mobile phone owned by Yamada Taro.

Meanwhile, the above-stated mobile terminal 2 may be implemented by installing a program in any computer such as a personal computer. That is, the above-stated interface section 21 and control section 23 may be embodied by the operation of a CPU of the computer in accordance with a program for implementing their functions. Therefore, the program for implementing the functions of the interface section 21 and the control section 23 as well as a recording medium with such a program recorded thereon also are one embodiment of the present invention. The data storage section 22 may be embodied by an internal storage device of a computer or a storage device that is accessible from this computer.

(Configuration of Spoken Dialog System)

The spoken dialog system 3 includes a communication processing section 31, a dialogue control section 32, a key input section 33, a screen display section 34, a speech input section 35, a speech output section 36, a speech recognition section 37 and a speech synthesis section 38.

The communication processing section 31 processes communication between the terminal device 2 and the dialogue control section 32. More specifically, the communication processing section 31 acquires user data transmitted from the terminal device 2. The communication processing section 31 further acquires at least one information of the reading information and the grammatical information transmitted from the terminal device 2. That is, the communication processing section 31 actively acquires at least one information of the reading information and the grammatical information in accordance with a request from the dialogue control section 32, or passively acquires at least one information of the reading information and the grammatical information irrespective of a request from the dialogue control section 32. The communication processing section 31 may store the acquired information in a memory. The communication processing section 31 outputs the acquired user data to the dialogue control section 32. The communication processing section 31 further outputs the at least one information of the reading information and the grammatical information to the dialogue control section 32.

The dialogue control section 32 detects an event of the spoken dialog system 3 or an event from the terminal device 2, and determines a response to the detected event. That is, the dialogue control section 32 detects an event of the control processing section 31, the key input section 33 or the speech recognition section 37, determines a response to the detected event and outputs the determined response to the communication processing section 31, the screen display section 34 and the speech synthesis section 38. Note here that the dialogue control section 32 can detect its own event as well as the event of the communication processing section 31, the key input section 33 or the speech recognition section 37. For instance, the dialogue control section 32 can detect as its own event the situation where a vehicle with the spoken dialog system 3 installed therein approaches a point to turn right or left, or the situation where the power supply of the spoken dialog system 3 is turned ON.

As one example, the dialogue control section 32 detects an event of the key input section 33, and instructs the communication processing device 31 to acquire user data stored in the data storage section 22 and at least one information of the reading information and the grammatical information stored in the data storage section 22. In the present embodiment, it is assumed that a user operates the key input section 33 to acquire all of the user data and the grammatical information stored in the data storage section 22. In this case, the dialogue control section 32 instructs the communication processing section 31 to acquire all of the user data and the grammatical information stored in the data storage section 22. Herein, in the case where user's utterance causes the terminal device 2 to originate a call to a mobile phone of the other party, the dialogue control section 32 may instruct the communication processing section 31 to acquire user data and grammatical information in a telephone directory on the persons to whom the caller makes a call frequently. Thereby, a recognition process by the speech recognition section 37 can be speeded up as compared with the case where all of the user data and grammatical information stored in the data storage section 22 are acquired and the speech recognition section 37 recognizes the input speech.

As another example, the dialogue control section 32 detects an event of the communication processing section 31 and outputs user data output from the communication processing device 31 to the screen display section 34. More specifically, the dialogue control section 32 inserts the user data output from the communication processing section 31 into a template for screen display that is prepared beforehand, and outputs a character string including the inserted user data to the screen display section 34. The dialogue control section 32 further outputs the user data and the grammatical information output from the communication processing section 31 to the speech recognition section 37. The dialogue control section 32 further outputs the reading information output from the communication processing section 31 to the speech synthesis section 38. More specifically, the dialogue control section 32 inserts the reading information output from the communication processing section 31 into a template for speech synthesis that is prepared beforehand, and outputs a character string including the inserted reading information to the speech synthesis section 38.

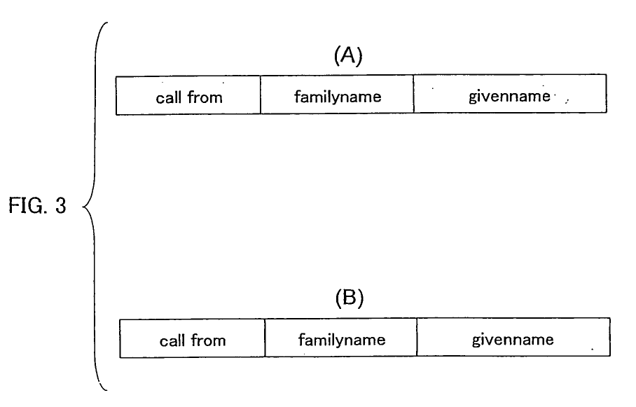

FIG. 3(a) shows an exemplary template for screen display. In the present embodiment, the user data on “family name” is associated with the template “familyname” and the user data on “given name” is associated with the template “givenname” of FIG. 3(a). The dialogue control section 32 inserts the user data “Yamada” in the template “familyname” and inserts the user data “Taro” in the template “givenname” of FIG. 3(a). The dialogue control section 32 then outputs a character string showing “call from Yamada Taro” to the screen display section 34.

FIG. 3(b) shows an exemplary template for speech synthesis. In the present embodiment, reading information on “family name” is associated with the template “familyname” and reading information on “given name” is associated with the template “givenname” of FIG. 3(b). The dialogue control section 32 inserts the reading information “yama'da” in the template “familyname” and inserts the reading information “'taroo” in the template “givenname” of FIG. 3(b). The dialogue control section 32 then outputs a character string showing “call from yama'da 'taroo” to the speech synthesis section 38.

The key input section 33 may be composed of any input device such as switches, a ten-key numeric pad, a remote control, a tablet, a touch panel, a keyboard, a mouse or the like. The key input section 33 outputs the input information to the dialogue control section 32. The dialogue control section 32 detects the input information output from the key input section 33 as an event.

The screen display section 34 may be composed of any display device such as a liquid crystal display, an organic EL display, a plasma display, a CRT display or the like. The screen display section 34 displays a character string output from the dialogue control section 32. In the present embodiment, the screen display section 34 displays “call from Yamada Taro”.

The speech input section 35 inputs utterance by a user as input speech. Note here that the speech input section 35 may be composed of a speech input device such as a microphone.

The speech output section 36 outputs synthesized speech output from the speech synthesis section 38. The speech output section 36 may be composed of an output device such as a speaker.

The speech recognition section 37 recognizes speech input to the speech input section 35. More specifically, the speech recognition section 37 compares the input speech with the grammatical information output from the dialogue control section 32 by acoustic analysis and extracts one having the best matching characteristics among the grammatical information output from the dialogue control section 32 to regard the user data of the extracted grammatical information as a recognition result. The speech recognition section 37 outputs the recognition result to the dialogue control section 32. The dialogue control section 32 detects the recognition result output from the speech recognition section 37 as an event. Herein the speech recognition section 37 may be provided with a recognition word dictionary storing the user data and the grammatical information output from the dialogue control section 32.

As one example, it is assumed that the dialogue control section 32 outputs the grammatical information “yamada” and “taroo” to the speech recognition section 37. In this case, when a user utters “yamadataroo”, the speech recognition section 37 recognizes this utterance, and regards the user data “Yamada Taro” of the grammatical information “yamada” and “taroo” as a recognition result. The speech recognition section 37 outputs “Yamada Taro” as the recognition result to the dialogue control section 32. Thereby, it is possible for the dialogue control section 32 to instruct the communication processing section 31 to originate a call to the mobile phone of Yamada Taro, for example. The communication processing section 31 transmits the instruction from the dialogue control section 32 to the terminal device 2.

The speech synthesis section 38 generates synthesized speech based on the reading information output from the dialogue control section 32. In the present embodiment, the speech synthesis section 38 generates synthesized speech showing “call from yama'da 'taroo”. The speech synthesis section 38 outputs the generated synthesized speech to the speech output section 36.

Meanwhile, the above-stated spoken dialog system 3 may be implemented by installing a program in any computer such as a personal computer. That is, the above-stated communication processing section 31, dialogue control section 32, key input section 33, screen display section 34, speech input section 35, speech output section 36, speech recognition section 37 and speech synthesis section 38 may be embodied by the operation of a CPU of the computer in accordance with a program for implementing their functions. Therefore, the program for implementing the functions of the communication processing section 31, the dialogue control section 32, the key input section 33, the screen display section 34, the speech input section 35, the speech output section 36, the speech recognition section 37 and the speech synthesis section 38 as well as a recording medium with such a program recorded thereon also are one embodiment of the present invention.

(Operation of Dialogue Control System)

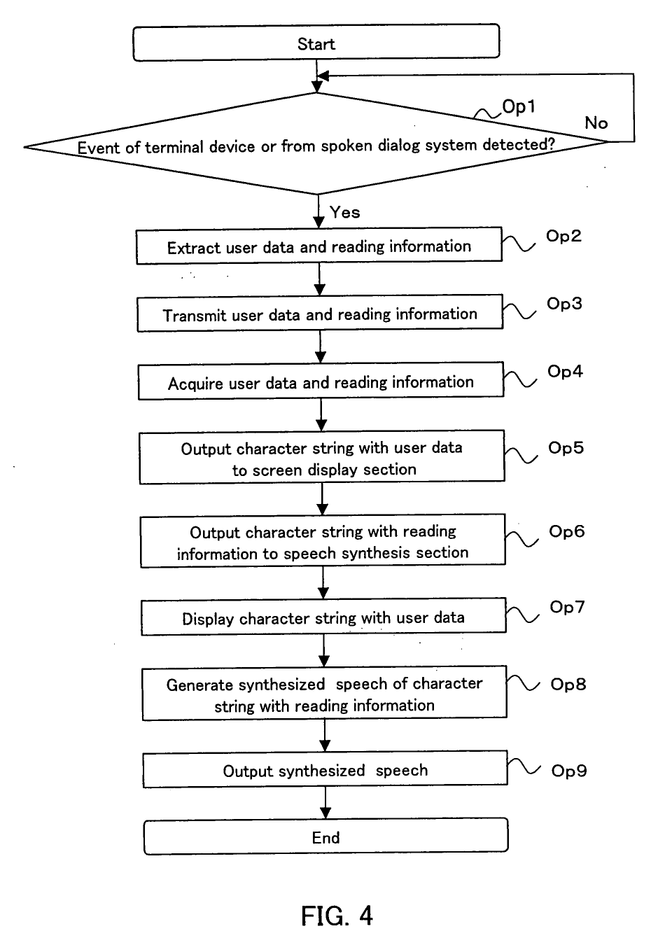

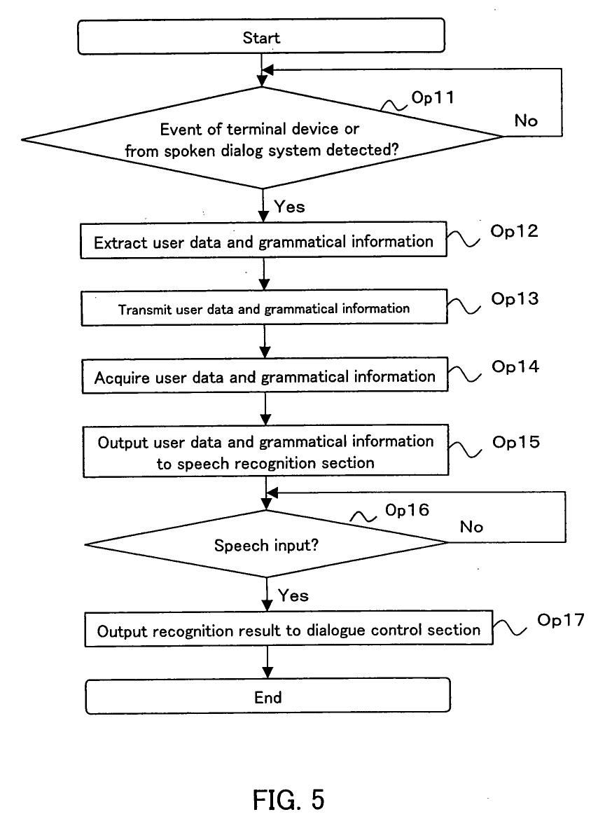

The following describes a process by the thus configured dialogue control system 1, with reference to FIGS. 4 and 5.

FIG. 4 is a flowchart briefly showing the process in which the spoken dialog system 3 acquires user data and reading information from the terminal device 2. That is, as shown in FIG. 4, when the control section 23 detects an event of the terminal device 2 or an event from the spoken dialog system 3 (YES at Step Op1), the control section 23 extracts user data and reading information stored in the data storage section 22 in accordance with a predetermined extraction rule (Step Op2). On the other hand, when the control section 23 does not detect any event of the terminal device 2 or from the spoken dialog system 3 (NO at Step Op1), the process returns to Step Op1.

The interface section 21 transmits the user data and reading information extracted at Step Op2 to the spoken dialog system 3 (Step Op3). The communication processing section 31 of the spoken dialog system 3 acquires the user data and reading information transmitted at Step Op3 (Step Op4). The dialogue control section 32 inserts the user data acquired at Step Op4 into a template for screen display that is prepared beforehand and outputs a character string including the inserted user data to the screen display section 34 (Step Op5). The dialogue control section 32 further inserts the reading information acquired at Step Op4 into a template for speech synthesis that is prepared beforehand, and outputs a character string including the inserted reading information to the speech synthesis section 38 (Step Op6). Note here that although FIG. 4 illustrates the mode where Step Op5 and Step Op6 are carried out in series, Step Op5 and Step Op6 may be carried out in parallel.

The screen display section 34 displays the character string output at Step Op5 (Step Op7). The speech synthesis section 38 generates synthesized speech of the character string output at Step Op6 (Step Op8). The speech output section 36 outputs the synthesized speech generated at Step Op8 (Step Op9). Note here that although FIG. 4 illustrates the mode where the character string output at Step Op5 is displayed at Step Op7, the process at Step Op5 and Step Op7 may be omitted when no character string is displayed on the screen display section 34.

FIG. 5 is a flowchart briefly showing the process in which the spoken dialog system 3 acquires user data and grammatical information from the terminal device 2. That is, as shown in FIG. 5, when the control section 23 detects an event of the terminal device 2 or an event from the spoken dialog system 3 (YES at Step Op11), the control section 23 extracts user data and grammatical information stored in the data storage section 22 in accordance with a predetermined extraction rule (Step Op12). On the other hand, when the control section 23 does not detect any event of the terminal device 2 or from the spoken dialog system 3 (NO at Step Op11), the process returns to Step Op11.

The interface section 21 transmits the user data and grammatical information extracted at Step Op12 to the spoken dialog system 3 (Step Op13). The communication processing section 31 of the spoken dialog system 3 acquires the user data and grammatical information transmitted at Step Op13 (Step Op14). The dialogue control section 32 outputs the user data and grammatical information acquired at Step Op14 to the speech recognition section 37 (Step Op15).

Herein, when the speech input section 35 inputs utterance by a user as input speech (YES at Step Op16), the speech recognition section 37 compares this input speech with grammatical information output at Step Op15 by acoustic analysis and extracts one having the best matching characteristics among the grammatical information output at Step Op15 to regard the user data of the extracted grammatical information as a recognition result. The speech recognition section 37 outputs the recognition result to the dialogue control section (Step Op17). On the other hand, if the speech input section 35 does not input any speech (NO at Step Op16), the process returns to Step Op16.

As stated above, according to the dialogue control system 1 of the present embodiment, the control section 23 detects an event of the terminal device 2 or an event from the spoken dialog system 3, and extracts at least one of the reading information and the grammatical information stored in the data storage section 22 based on the detected event. The interface section 21 transmits the at least one of the reading information and the grammatical information extracted by the control section 23 to the spoken dialog system 3. The communication processing section 31 acquires the at least one of the reading information and the grammatical information transmitted by the interface section 21. The speech synthesis section 38 generates synthesized speech using the reading information acquired by the communication processing section 31. The speech recognition section 37 recognizes the input speech using the grammatical information acquired by the communication processing section 31. Thereby, even without a speech information database and retrieval means in the spoken dialog system 3 that are required in the above-stated conventional configuration, the speech synthesis section 38 can generate synthesized speech using reading information containing prosodic information, and the speech recognition section 37 can recognize input speech using grammatical information indicating recognition grammar. Therefore, naturally synthesized speech can be generated and input speech can be recognized without an increase of the cost of the spoken dialog system 3. Herein, the grammatical information shows one or a plurality of recognition grammars for an item value of at least one item in the user data. Thus, even if there are a plurality of ways to speak concerning the item value of at least one item in the user data, the utterance (input speech) conducted in a plurality of ways can be recognized, as long as the recognition grammars cover such a plurality of ways of speaking.

FIG. 4 describes the process in which the spoken dialog system 3 acquires user data and reading information from the terminal device 2 and FIG. 5 describes the process in which the spoken dialog system 3 acquires user data and grammatical information from the terminal device 2. However, the present embodiment is not limited to them. The spoken dialog system 3 may acquire user data, reading information and grammatical information from the terminal device 2.

The thus described specific examples are just preferable embodiments of the dialogue control system 1 according to the present invention, and they may be modified variously, e.g., for the content of the entry stored in the data storage section 22, the templates used by the dialogue control section 32 and the like.

(First Modification)

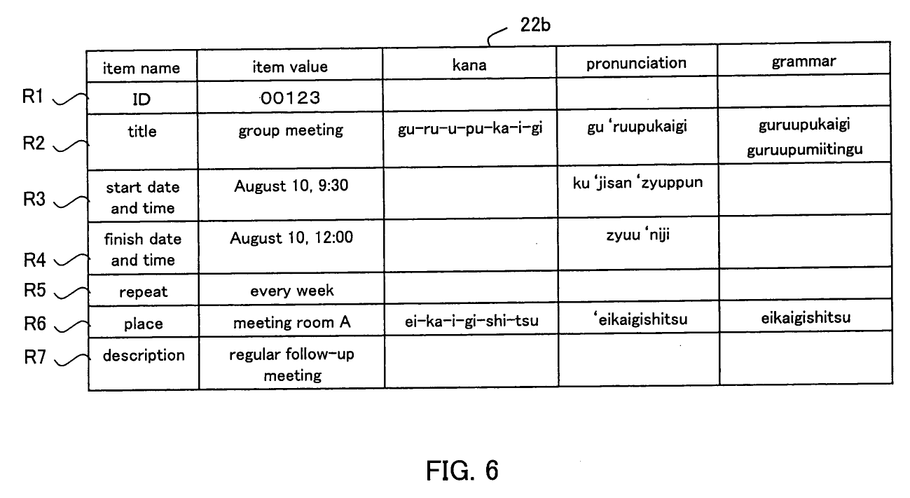

As one example, the following describes a first modification example in which the terminal device 2 is a PDA. FIG. 6 shows an exemplary data configuration of the data storage section 22 in the first modification example. As shown in FIG. 6, the data storage section 22 stores item names, item values, kana, pronunciation and grammar as entry 22b. In the first line R1 of the entry 22b, the item name “ID” and the item value “00123” are stored. The “ID” is an identification code for uniquely identifying the entry 22b. In the second line R2, the item name “title”, the item value “group meeting”, the kana “gu-ru-u-pu-ka-i-gi”, the pronunciation “gu'ruupukaigi” and the grammar “guruupukaigi” and “guruupumiitingu” are stored. That is, for the item value “group meeting”, grammatical information showing two recognition grammars of “guruupukaigi” and “guruupumiitingu” is stored. In the third line R3, the item name “start date and time”, the item value “August 10, 9:30”, and the pronunciation “ku'jisan'zyuppun” are stored. In the fourth line R4, the item name “finish date and time”, the item value “August 10, 12:00” and the pronunciation “zyuu'niji” are stored. In the fifth line R5, the item name “repeat” and the item value “every week” are stored. In the sixth line R6, the item name “place”, the item value “meeting room A”, the kana “ei-ka-i-gi-shi-tsu”, the pronunciation “'eikaigishitsu” and the grammar “eikaigishitsu” are stored. In the seventh line R7, the item name “description” and the item value “regular follow-up meeting” are stored. In this way, the data storage section 22 in the first modification example stores the user data of the terminal device 2 concerning the schedule, which is just an example.

For example, when there is a request issued from the spoken dialog system 3 for acquiring reading information and grammatical information, the control section 23 extracts user data and the reading information and the grammatical information of this user data stored in the data storage section 22 in accordance with a predetermined extraction rule. It is assumed that the extraction rule in this case is a rule for extracting the reading information and the grammatical information on the item values of the user data “title”, “start date and time”, “finish date and time” and “place”. More specifically, the control section 23 extracts the user data “group meeting”, the start date and time “August 10, 9:30”, the finish date and time “August 10, 12:00” and the place “meeting room A” stored in the data storage section 22 in accordance with the request from the spoken dialog system 3. The control section 23 further extracts the reading information “gu'ruupukaigi”, “ku'jisan'zyuppun”, “zyuu'niji” and “'eikaigishitsu”. The control section 23 still further extracts the grammatical information “guruupukaigi”, “guruupumiitingu” and “eikaigishitsu”. The control section 23 outputs the extracted information to the interface section 21. The interface section 21 transmits the user data “group meeting” the start date and time “August 10, 9:30”, the finish date and time “August 10, 12:00” and the place “meeting room A”, the reading information “gu'ruupukaigi”, “ku'jisan'zyuppun”, “zyuu'niji” and “'eikaigishitsu” and the grammatical information “guruupukaigi”, “guruupumiitingu” and “eikaigishitsu” output from the control section 23 to the spoken dialog system 3. Thereby, when the user utters “guruupukaigi” or “guruupumiitingu”, for example, the spoken, dialog system 3 can recognize this utterance and read aloud the schedule of the group meeting, for example, in a natural prosodic manner with synthesized speech.

Note here that the request issued from the spoken dialog system 3 for acquiring the reading information and the grammatical information may be a request for extracting all reading information and grammatical information stored in the data storage section 22, or a rule for extracting the reading information and grammatical information of the schedule designated by the user of the spoken dialog system 3 (e.g., today's schedule, weekly schedule).

The dialogue control section 32 inserts the user data output from the communication processing section 31 into a template for screen display that is prepared beforehand, and outputs a character string including the inserted user data to the screen display section 34. The dialogue control section 32 further outputs the user data and the grammatical information output from the communication processing section 31 to the speech recognition section 37. Moreover, the dialogue control section 32 inserts the reading information output from the communication processing section 31 into a template for speech synthesis that is prepared beforehand, and outputs a character string including the inserted reading information to the speech synthesis section 38.

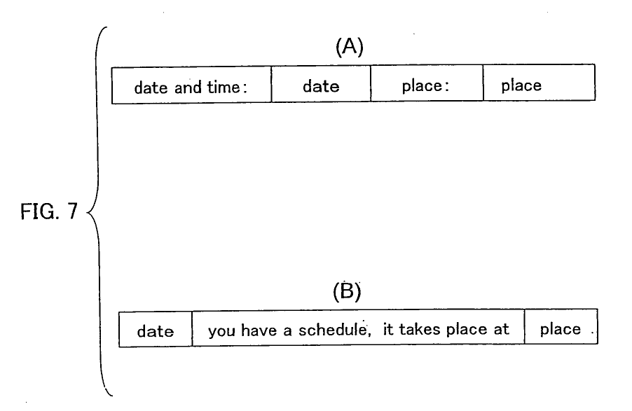

FIG. 7(a) shows an exemplary template for screen display in the first modification example. In the present embodiment, the template “date” of FIG. 7(a) is associated with the user data of “start date and time”, and the template “place” is associated with the user data of “place”. The dialogue control section 32 inserts the user data “August 10, 9:30” in the template “date”, and the user data “meeting room A” in the template “place” of FIG. 7(a). The dialogue control section 32 outputs a character string indicating “date and time: August 10, 9:30, place: meeting room A” to the screen display section 34. Thereby, the screen display section 34 displays “date and time: August 10, 9:30, place: meeting room A”.

FIG. 7(b) shows an exemplary template for speech synthesis in the first modification example. In the present embodiment, the template “date” of FIG. 7(b) is associated with the reading information of “start date and time”, and the template “place” is associated with the reading information of the “place”. The dialogue control section 32 inserts the reading information “ku'jisan'zyuppun” in the template “date” of FIG. 7(b) and the reading information “'eikaigishitsu” in the template “place”. The dialogue control section 32 then outputs a character string indicating “ku'jisan'zyuppun, you have a schedule, it takes place at 'eikaigishitsu.” to the speech synthesis section 38. Thereby, the speech synthesis section 38 generates synthesized speech indicating “ku'jisan'zyuppun, you have a schedule, it takes place at 'eikaigishitsu.”.

The speech recognition section 37 recognizes the speech input to the speech input section 35. For instance, it is assumed that the dialogue control section 32 outputs the grammatical information “guruupukaigi”, “guruupumiitingu” and “eikaigishitsu”. In this case, when the user utters “guruupukaigi”, the speech recognition section 37 recognizes this utterance and regards the user data “group meeting” corresponding to the grammatical information “guruupukaigi” as the recognition result. Likewise, even when the user utters “guruupumiitingu”, the speech recognition section 37 recognizes this utterance, and regards the user data “group meeting” corresponding to the grammatical information “guruupumiitingu” as the recognition result. In this way, even in the case where the user utters an abbreviation or a commonly used name of the user data other than the formal designation, the speech recognition section 37 can recognize this utterance. The speech recognition section 37 outputs the “group meeting” as the recognition result to the dialogue control section 32. Thereby, the dialogue control section 32 can instruct the communication processing section 31 to acquire the schedule of the group meeting, for example. The communication processing section 31 transmits the instruction from the dialogue control section 32 to the terminal device 2.

(Second Modification)

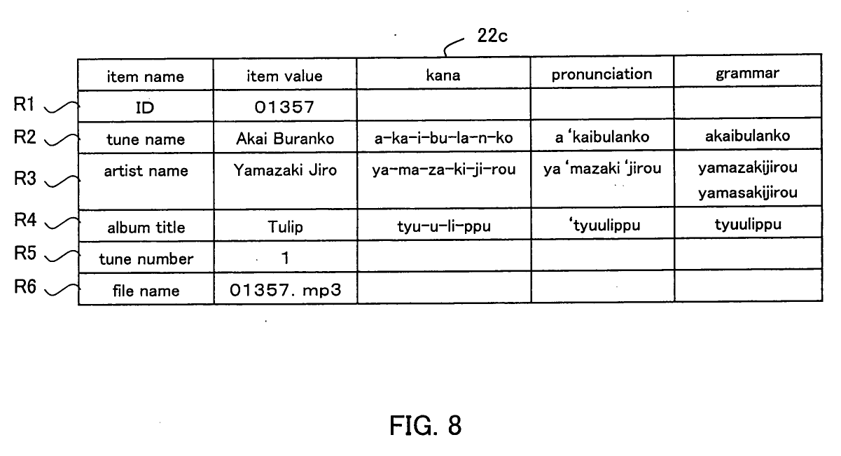

As another example, the following describes a second modification example in which the terminal device 2 is a music player. FIG. 8 shows an exemplary data configuration of the data storage section 22 in the second modification example. As shown in FIG. 8, the data storage section 22 stores item names, item values, kana, pronunciation and grammar as entry 22c. In the first line R1 of the entry 22c, the item name “ID” and the item value “01357” are stored. The “ID” is an identification code for uniquely identifying the entry 22c. In the second line R2, the item name “tune name”, the item value “Akai Buranko”, the kana “a-ka-i-bu-la-n-ko”, the pronunciation “a'kaibulanko” and the grammar “akaibulanko” are stored. In the third line R3, the item name “artist name”, the item value “Yamazaki Jiro”, the kana “ya-ma-za-ki-ji-rou”, the pronunciation “ya'mazaki'jirou” and the grammars “yamazakijirou” and “yamasakijirou” are stored. In the fourth line R4, the item name “album title”, the item value “Tulip”, the kana “tyu-u-li-ppu”, the pronunciation “'tyuulippu” and the grammar “tyuulippu” are stored. In the fifth line R5, the item name “tune number” and the item value “1” are stored. In the sixth line R6, the item name “file name” and the item value “01357.mp3” are stored. In this way, the entry 22c of FIG. 8 stores user data of a tune in the terminal device 2, which is just an example.

For example, when there is a request issued from the spoken dialog system 3 for acquiring reading information and grammatical information, the control section 23 extracts user data and the reading information and the grammatical information of this user data stored in the data storage section 22 in accordance with a predetermined extraction rule. It is assumed that the extraction rule in this case is a rule for extracting the reading information and the grammatical information on the item values of the user data “tune name” and “artist name”. More specifically, the control section 23 extracts the user data “Akai Buranko” and “Yamazaki Jiro”, the reading information “a'kaibulanko” and “ya'mazaki'jirou” and the grammatical information “akaibulanko”, “yamazakijirou” and “yamasakijirou” stored in the data storage section 22 in accordance with the request from the spoken dialog system 3. The control section 23 outputs the extracted information to the interface section 21. The interface section 21 transmits the user data “Akai Buranko” and “Yamazaki Jiro”, the reading information “a'kaibulanko” and “ya'mazaki'jirou” and the grammatical information ““akaibulanko”, “yamazakijirou” and “yamasakijirou” output from the control section 23 to the spoken dialog system 3. Thereby, when the user utters “akaibulanko”, for example, the spoken dialog system 3 can recognize this utterance and instruct the terminal device 2 to reproduce the tune of Akai Buranko. Further, the spoken dialog system 3 can read aloud the tune name reproduced by the terminal device 2 and the artist name thereof in a natural prosodic manner with synthesized speech.

Note here that the request issued from the spoken dialog system 3 for acquiring the reading information and the grammatical information may be a request for extracting all reading information and grammatical information stored in the data storage section 22, or a rule for extracting the reading information and grammatical information of the tune name or the artist name designated by the user of the spoken dialog system 3. Alternatively, this may be a request for acquiring the reading information and the grammatical information of the tune that is frequently reproduced.

The dialogue control section 32 inserts the user data output from the communication processing section 31 into a template for screen display that is prepared beforehand, and outputs a character string including the inserted user data to the screen display section 34. The dialogue control section 32 further outputs the user data and the grammatical information output from the communication processing section 31 to the speech recognition section 37. Moreover, the dialogue control section 32 inserts the reading information output from the communication processing section 31 into a template for speech synthesis that is prepared beforehand, and outputs a character string including the inserted reading information to the speech synthesis section 38.

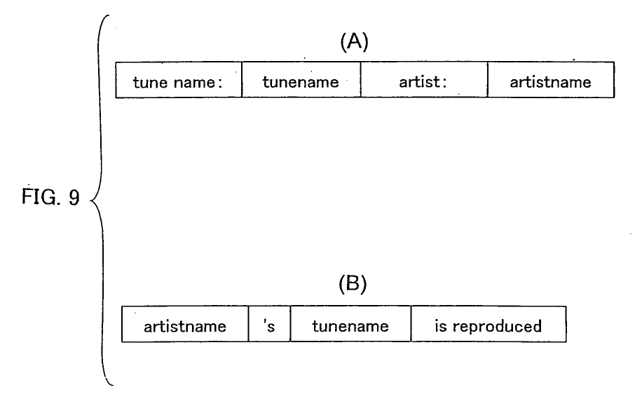

FIG. 9(a) shows an exemplary template for screen display in the second modification example. In the present embodiment, the template “tunename” of FIG. 9(a) is associated with the user data of “tune name”, and the template “artistname” is associated with the user data of “artist name”. The dialogue control section 32 inserts the user data “Akai Buranko” in the template “tunename” of FIG. 9(a), and the user data “Yamazaki Jiro” in the template “artistname”. The dialogue control section 32 outputs a character string indicating “tune name: Akai Buranko, artist: Yamazaki Jiro” to the screen display section 34. Thereby, the screen display section 34 displays “tune name: Akai Buranko, artist: Yamazaki Jiro”.

FIG. 9(b) shows an exemplary template for speech synthesis in the second modification example. In the present embodiment, the template “tunename” of FIG. 9(b) is associated with the reading information of “tune name”, and the template “artistname” is associated with the reading information of the “artist name”. The dialogue control section 32 inserts the reading information “ya'mazaki'jirou” into the template “artistname” of FIG. 9(b) and the reading information “a'kaibulanko” into the template “tunename”. The dialogue control section 32 outputs a character string indicating “ya'mazaki'jirou 's a'kaibulanko is reproduced” to the speech synthesis section 38. Thereby, the speech synthesis section 38 generates synthesized speech indicating “ya'mazaki'jirou 's a'kaibulanko is reproduced”.

The speech recognition section 37 recognizes the speech input to the speech input section 35. For instance, it is assumed that the dialogue control section 32 outputs the grammatical information “akaibulanko”, “yamazakijirou” and “yamasakijirou”. In this case, when the user utters “akaibulanko”, the speech recognition section 37 recognizes this utterance and regards the user data “Akai Buranko” corresponding to the grammatical information “akaibulanko” as the recognition result. The speech recognition section 37 outputs the “Akai Buranko” as the recognition result to the dialogue control section 32. Thereby, the dialogue control section 32 can instruct the communication processing section 31 to reproduce the tune of Akai Buranko, for example. The communication processing section 31 transmits the instruction from the dialogue control section 32 to the terminal device 2.

### Embodiment 2

Embodiment 1 describes the example where the terminal device is connected with the spoken dialog system, whereby the spoken dialog system acquires at least one of the reading information and the grammatical information stored in the data storage section of the terminal device so as to generate synthesized speech based on the acquired reading information and recognize input speech based on the acquired grammatical information. On the other hand, Embodiment 2 describes an example where a terminal device is connected with a speech information management device, whereby the terminal device acquires user data stored in a user data storage section of the speech information management device and at least one of reading information and grammatical information stored in a speech information database as speech data, and stores the acquired speech data in a data storage section.

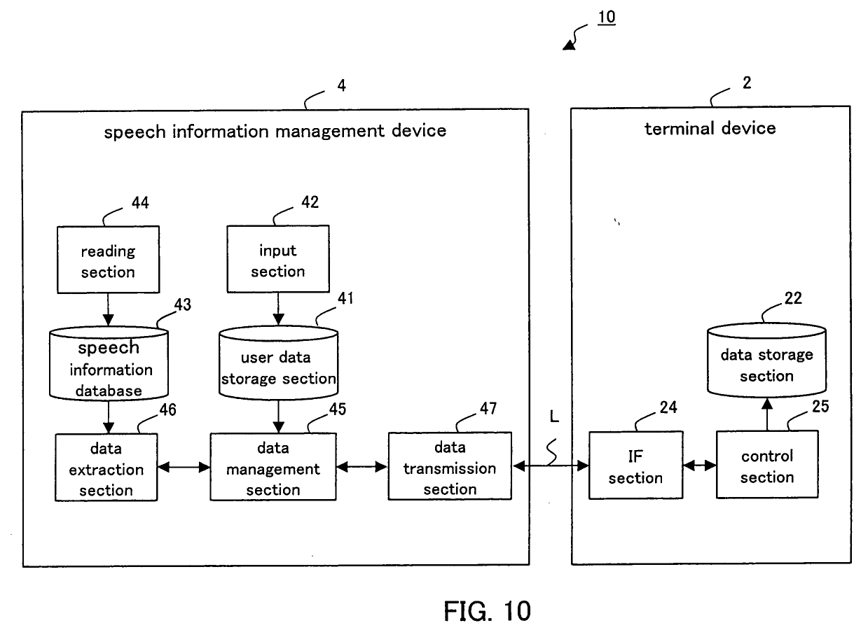

FIG. 10 is a block diagram schematically showing the configuration of a dialogue control system 10 according to the present embodiment. In FIG. 10, the same reference numerals are assigned to the elements having the same functions as in FIG. 1, and their detailed explanations are not repeated.

Namely, the dialogue control system 10 according to the present embodiment includes a speech information management device 4 instead of the spoken dialog system 3 of FIG. 1. The terminal device 2 and the speech information management device 4 are connected with each other via a cable L. Note here that the terminal device 2 and the speech information management device 4 may be accessible from each other by radio.

In the present embodiment, the following exemplifies the case where the terminal device 2 is a mobile phone and the speech information management device 4 is a personal computer.

(Configuration of Speech Information Management Device)

The speech information management device 4 includes a user data storage section 41, an input section 42, a speech information database 43, a reading section 44, a data management section 45, a data extraction section 46 and a data transmission section 47.

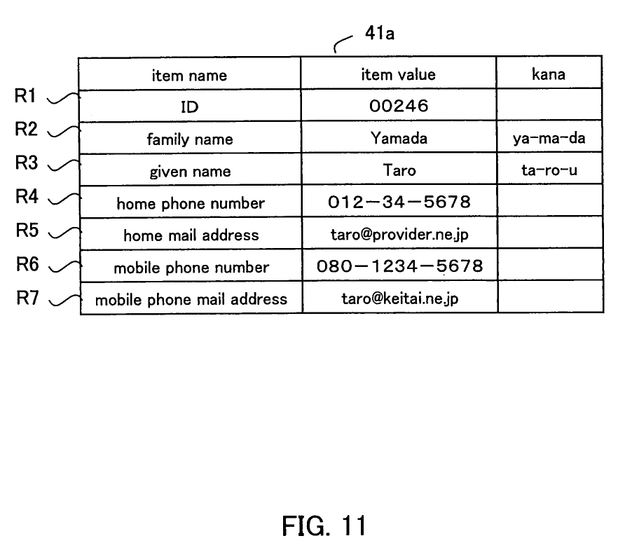

The user data storage section 41 stores user data. FIG. 11 shows an exemplary data configuration of the user data storage section 41. As shown in FIG. 11, the user data storage section 41 stores item names, item values and kana as entry 41a. The item name indicates a designation of an item. The item value shows the content corresponding to the item name. The kana shows how to read the item value.

As shown in FIG. 11, in the first line R1 of the entry 41a, the item name “ID” and the item value “00246” are stored. The “ID” is an identification code for uniquely identifying the entry 41a. In the second line R2, the item name “family name”, the item value “Yamada” and the kana “ya-ma-da” are stored. In the third line R3, the item name “given name”, the item value “Taro” and the kana “ta-ro-u” are stored. In the fourth line R4, the item name “home phone number” and the item value “012-34-5678” are stored. In the fifth line R5, the item name “home mail address” and the item value “taro@provider.ne.jp” are stored. In the sixth line R6, the item name “mobile phone number” and the item value “080-1234-5678” are stored. In the seventh line R7, the item name “mobile phone mail address” and the item value “taro@keitai.ne.jp” are stored. That is, the user data storage section 41 stores user data in a telephone directory, which is just an example.

The input section 42 allows a user of the speech information management device 4 to input user data. User data input through the input section 42 is stored in the user data storage section 41. The input section 42 may be composed of any input device such as a keyboard, a mouse, a ten-key numeric pad, a tablet, a touch panel, a speech recognition device or the like.

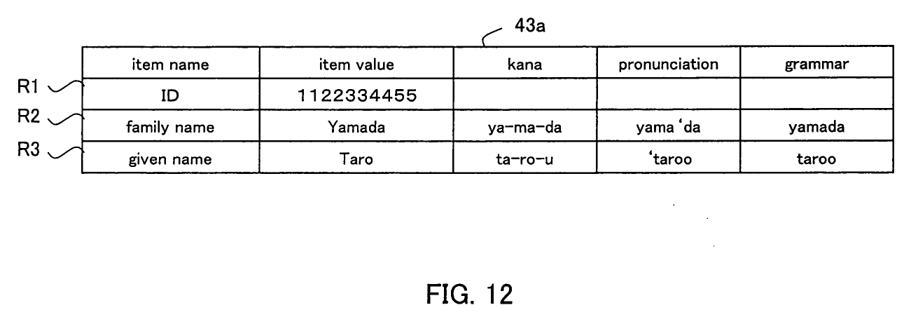

The speech information database 43 stores reading information including prosodic information of item values of user data and grammatical information indicating one or a plurality of recognition grammars of item values of user data. FIG. 12 through FIG. 14 show exemplary data configurations of the speech information database 43. As shown in FIGS. 12 to 14, the speech information database 43 stores an item name, an item value, kana, pronunciation and grammar as entries 43a to 43c. That is, the speech information database 43 stores the entry 43a, the entry 43b and the entry 43c. Herein, the pronunciation indicates how to pronounce an item value (prosody) and the grammar indicates a recognition grammar of an item value.

As shown in FIG. 12, in the first line R1 of the entry 43a, the item name “ID” and the item value “1122334455” are stored. The “ID” is an identification code for uniquely identifying the entry 43a. In the second line R2, the item name “family name”, the item value “Yamada”, the kana “ya-ma-da”, the pronunciation “yama'da” and the grammar “yamada” are stored. In the third line R3, the item name “given name”, the item value “Taro”, the kana “ta-ro-u”, the pronunciation “'taroo” and the grammar “taroo” are stored.

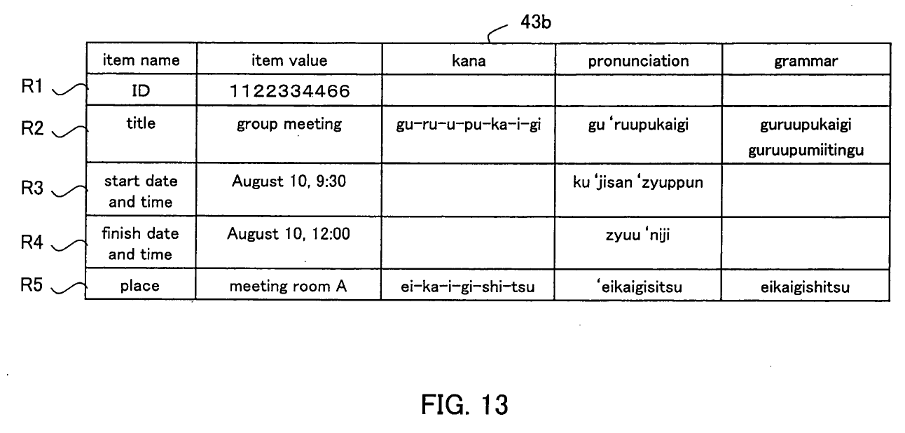

As shown in FIG. 13, in the first line R1 of the entry 43b, the item name “ID” and the item value “1122334466” are stored. The “ID” is an identification code for uniquely identifying the entry 43b. In the second line R2, the item name “title”, the item value “group meeting”, the kana “gu-ru-u-pu-ka-i-gi”, the pronunciation “gu'ruupukaigi” and the grammar “guruupukaigi” and “guruupumiitingu” are stored. In the third line R3, the item name “start date and time”, the item value “August 10, 9:30”, and the pronunciation “ku'jisan'zyuppun” are stored. In the fourth line R4, the item name “finish date and time”, the item value “August 10, 12:00” and the pronunciation “zyuu'niji” are stored. In the fifth line R5, the item name “place”, the item value “meeting room A”, the kana “ei-ka-i-gi-shi-tsu”, the pronunciation “'eikaigishitsu” and the grammar “eikaigishitsu” are stored.

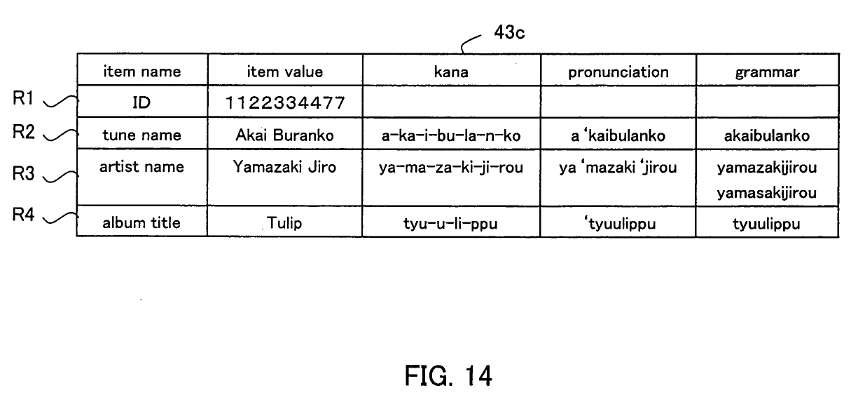

As shown in FIG. 14, in the first line R1 of the entry 43c, the item name “ID” and the item value “1122334477” are stored. The “ID” is an identification code for uniquely identifying the entry 43c. In the second line R2, the item name “tune name”, the item value “Akai Buranko”, the kana “a-ka-i-bu-la-n-ko”, the pronunciation “a'kaibulanko” and the grammar “akaibulanko” are stored. In the third line R3, the item name “artist name”, the item value “Yamazaki Jiro”, the kana “ya-ma-za-ki-ji-rou”, the pronunciation “ya'mazaki'jirou” and the grammars “yamazakijirou” and “yamasakijirou” are stored. In the fourth line R4, the item name “album title”, the item value “Tulip”, the kana “tyu-u-li-ppu”, the pronunciation “'tyuulippu” and the grammar “tyuulippu” are stored.

The reading section 44 reads out data from a recording medium such as a flexible disk (FD), a compact disk read only memory (CD-ROM), a magneto optical disk (MO) or a digital versatile disk (DVD). When the user of the speech information management device 4 makes the reading section 44 read out reading information and grammatical information stored in a recording medium, the speech information database 43 stores the reading information and the grammatical information as shown in FIGS. 12 to 14.

When the terminal device 2 is connected with the speech information management device 4, the data management section 45 extracts user data stored in the user data storage section 41. In the present embodiment, the data management section 45 extracts the entry 41a of FIG. 11. The data management section 45 outputs the extracted user data to the data extraction section 46. Note here that if a predetermined time period has elapsed since the terminal device 2 is connected with the speech information management device 4, if there is an instruction from a user or at the time designated by the user, the data management section 45 may extract the user data stored in the user data storage section 41.

The data extraction section 46 extracts at least one of the reading information and the grammatical information stored in the speech information database 43 in accordance with item values of the user data output from the data management section 45. In the present embodiment, the data extraction section 46 retrieves records corresponding to the user data “Yamada” and “Taro” output from the data management section 45, thereby extracting the reading information “yama'da” and “'taroo” and the grammatical information “yamada” and “taroo” stored in the entry 43a of the speech information database 43. The data extraction section 46 outputs the extracted reading information and grammatical information to the data management section 45. Incidentally, the data extraction section 46 may extract the reading information and the grammatical information stored in the speech information database 43 in accordance with the user data and the kana. Thereby, even in the case where the notation is the same between item values of the user data but their kana (how to read them) is different, the data extraction section 46 can extract desired reading information and grammatical information.

The data management section 45 associates an item value of the user data with the at least one of the reading information and the grammatical information output from the data extraction section 46, thus generating speech data. In the present embodiment, the user data “Yamada” of the entry 41a of FIG. 11 is associated with the reading information “yama'da” and the grammatical information “yamada” and the user data “Taro” is associated with the reading information “'taroo” and the grammatical information “taroo”, thus generating speech data. The data management section 45 outputs the generated speech data to the data transmission section 47.

The data transmission section 47 deals with the communication between the terminal device 2 and the data management section 45. More specifically, the data transmission section 47 transmits speech data output from the data management section 45 to the terminal device 2.

Meanwhile, the above-stated speech information management device 4 may be implemented by installing a program in any computer such as a personal computer. That is, the above-stated input section 42, reading section 44, data management section 45, data extraction section 46 and data transmission section 47 may be embodied by the operation of a CPU of the computer in accordance with a program for implementing their functions. Therefore, the program for implementing the functions of the input section 42, the reading section 44, the data management section 45, the data extraction section 46 and the data transmission section 47 as well as a recording medium with such a program recorded thereon also are one embodiment of the present invention. The user data storage section 41 and the speech information database 43 may be embodied by an internal storage device of a computer or a storage device that is accessible from this computer.

(Configuration of Terminal Device)

The terminal device 2 includes an interface section 24 and a control section 25 instead of the interface section 21 and the control section 23 of FIG. 1.

The interface section 24 is an interface between the speech information management device 4 and the control section 25. More specifically, the interface section 24 acquires speech data transmitted from the speech information management device 4. The interface section 21 outputs the acquired speech data to the control section 25.

The control section 25 stores the speech data output from the interface section 24 to the data storage section 22. Thereby, as shown in FIG. 2, the data storage section 22 stores user data, reading information and grammatical information.

(Operation of Dialogue Control System)

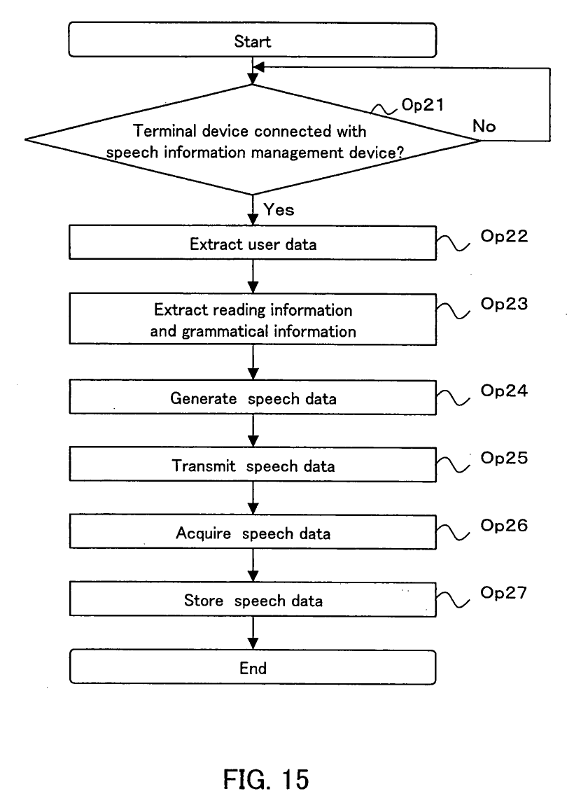

The following describes the process of the thus configured dialogue control system 10, with reference to FIG. 15.

FIG. 15 is a flowchart briefly showing the process of the terminal device 2 to acquire user data, reading information and grammatical information from the speech information management device 4. That is, as shown in FIG. 15, if the terminal device 2 is connected with the speech information management device 4 (YES at Step Op21), the data management section 45 extracts user data stored in the user data storage section 41 (Step Op22). On the other hand, if the terminal device 2 is not connected with the speech information management device 4 (NO at Step Op21), the process returns to Step Op21.

The data extraction section 46 extracts reading information and grammatical information stored in the speech information database 43 in accordance with item values of the user data extracted at Step Op22 (Step Op23). The data management section 45 associates an item value of the user data with the reading information and grammatical information extracted at Step Op23, thus generating speech data (Step Op24). The data transmission section 47 transmits the speech data generated at Step Op24 to the terminal device 2 (Step Op25).

The interface section 24 of the terminal device 2 acquires the speech data transmitted at Step Op25 (Step Op26). The control section 25 stores the speech data acquired at Step Op26 in the data storage section 22 (Step Op27). Thereby, the data storage section 22 stores user data, reading information and grammatical information as shown in FIG. 2.

As stated above, according to the dialogue control system 10 of the present embodiment, the data management section 45 detects an event of the speech information management device 4 or an event from the terminal device 2, and extracts user data from the user data storage section 41 based on the detected event. The data extraction section 46 extracts at least one of the reading information and the grammatical information stored in the speech information database 43 in accordance with item values of the user data extracted by the data management section 45. The data management section 45 associates an item value of the user data with the at least one of the reading information and the grammatical information extracted by the data extraction section 46 so as to generate speech data. Thereby, it is possible for the data transmission section 47 to transmit the speech data generated by the data management section 45 to the terminal device 2. Thus, the data storage section 22 of the terminal device 2 stores at least one of the reading information and the grammatical information.

Herein, FIG. 15 describes the process in which the terminal device 2 acquires user data, reading information and grammatical information from the speech information management device 4. However, this is not a limiting example. That is, the terminal device 2 may acquire user data from the speech information management device 4 and acquire at least one of reading information and grammatical information from the speech information management device 4.

The above description exemplifies the speech information management device provided with the user data storage section, which is not a limiting example. That is, the terminal device may be provided with a user data storage section. In such a case, the speech information management device may acquire user data from the user data storage section of the terminal device and extract reading information and grammatical information from a speech information database of the speech information management device in accordance with item values of the acquired user data. The speech information management device associates an item value of the user data with the reading information and the grammatical information, thus generating speech data. The speech information management device transmits the speech data to the terminal device.

The thus described specific examples are just preferable embodiments of the dialogue control system 10 according to the present invention, and they may be modified variously, e.g., for the extraction process of reading information and grammatical information by the data extraction section 46.

(Modification Example of Extraction Process by Data Extraction Section)

The following describes one modification example of the extraction process by the data extraction section 46 at Step Op23 of FIG. 15. More specifically, in this modification example, the data extraction section 46 extracts reading information and grammatical information about a place that is stored in the speech information database 43 in accordance with item values of the address of the user data.

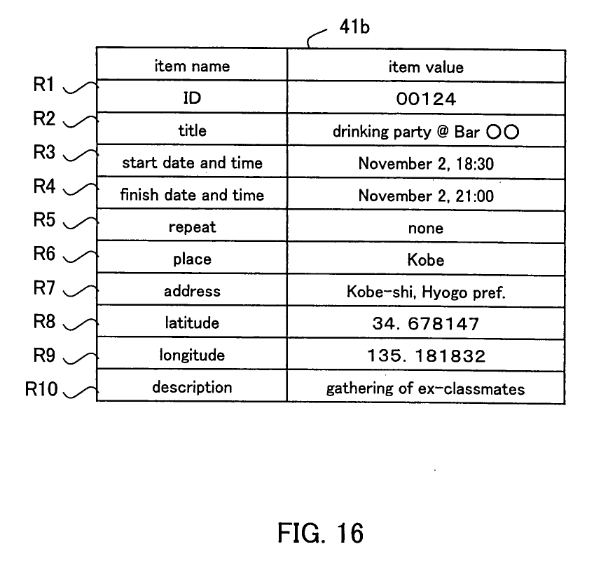

FIG. 16 shows an exemplary data configuration of the user data storage section 41 in this modification example. As shown in FIG. 16, the user data storage section 41 stores item names and item values as entry 41b. In the first line R1 of the entry 41b, the item name “ID” and the item value “00124” are stored. The “ID” is an identification code for uniquely identifying the entry 41b. In the second line R2, the item name “title” and the item value “drinking party @ Bar ∘∘” are stored. In the third line R3, the item name “start date and time” and the item value “November 2, 18:30” are stored. In the fourth line R4, the item name “finish date and time” and the item value “November 2, 21:00” are stored. In the fifth line R5, the item name “repeat” and the item value “none” are stored. In the sixth line R6, the item name “place” and the item value “Kobe” are stored. In the seventh line R7, the item name “address” and the item value “Kobe-shi, Hyogo pref.” are stored. In the eighth line R8, the item name “latitude” and the item value “34.678147” are stored. In the ninth line R9, the item name “longitude” and the item value “135.181832” are stored. In the tenth line R10, the item name “description” and the item value “gathering of ex-classmates” are stored.

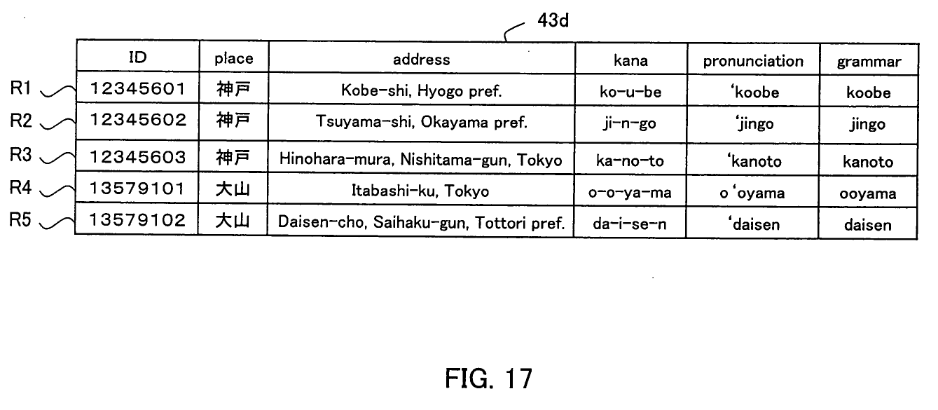

FIG. 17 shows an exemplary data configuration of the speech information database 43 in this modification example. As shown in FIG. 17, the speech information database 43 stores IDs, places, addresses, kana and ways of reading and grammars as entry 43d. In the first line R1 of the entry 43d, the ID “12345601”, the place [symbol] the address “Kobe-shi, Hyogo pref.”, the kana “ko-u-be”, the reading “'koobe” and the grammar “koobe” are stored. In the second line R2, the ID “12345602”, the place [symbol] the address “Tsuyama-shi, Okayama pref.”, the kana “ji-n-go”, the reading “'jingo” and the grammar “jingo” are stored. In the third line R3, the ID “12345603”, the place [symbol] the address “Hinohara-mura, Nishitama-gun, Tokyo”, the kana “ka-no-to”, the reading “'kanoto” and the grammar “kanoto” are stored. In the fourth line R4, the ID “13579101”, the place [symbol] the address “Itabashi-ku, Tokyo”, the kana “o-o-ya-ma”, the reading “o'oyama” and the grammar “ooyama” are stored. In the fifth line R5, the ID “13579102”, the place [symbol] the address “Daisen-cho, Saihaku-gun, Tottori pref.”, the kana “da-i-se-n”, the reading “'daisen” and the grammar “daisen” are stored. That is to say, in the first line R1 to the third line R3 of the entry 43d, their notation of the places is the same as [symbol] but their ways of reading are different from each other. Also, in the fourth line R4 and the fifth line R5 of the entry 43d, their notation of the places is the same as [symbol] but their ways of reading are different from each other.

Herein, when the terminal device 2 is connected with the speech information management device 4, the data management section 45 extracts the address “Kobe-shi, Hyogo pref.” of the user data that is stored in the user data storage section 41. The data management section 45 outputs the extracted user data “Kobe-shi, Hyogo pref.” to the data extraction section 46.

The data extraction section 46 retrieves a record corresponding to the user data “Kobe-shi, Hyogo pref.” output from the data management section 45, thereby extracting the reading information “'koobe” and the grammatical information “koobe” that are stored as the entry 43d in the speech information database 43. That is, the data extraction section 46 extracts the reading information and the grammatical information on the place that are stored in the speech information database 43 in accordance with item values of the address of the user data, and therefore even in the case where places in the user data have the same notation but are different in reading information and grammatical information, desired reading information and grammatical information can be extracted. The data extraction section 46 outputs the extracted reading information “'koobe” and the grammatical information “koobe” to the data management section 45.

The data management section 45 associates the place [symbol] of the user data in the entry 41b of FIG. 16b with the reading information “'koobe” and the grammatical information “koobe” output from the data extraction section 46, thereby generating speech data. The data management section 45 outputs the generated speech data to the data transmission section 47. The data transmission section 47 transmits the speech data output from the data management section 45 to the terminal device 2.

Meanwhile, the above description exemplifies the case where the data extraction section 46 extracts the reading information and the grammatical information on the places that are stored in the speech information database 43 in accordance with the item values of the address in the user data. However, the present embodiment is not limited to this example. For instance, the data extraction section 46 may extract reading information and grammatical information on a place stored in the speech information database 43 in accordance with item values of latitude and longitude in the user data. Thereby, even in the case where places in the user data have the same notation but are different in reading information and grammatical information, the data extraction section 46 can extract desired reading information and grammatical information.

Alternatively, the data extraction section 46 may extract reading information and grammatical information on a place that are stored in the speech information database 43 in accordance with item values of the place in the user data. For instance, suppose the user data on a place in the entry 41b of FIG. 16 stores “Bar ∘∘ in Kobe”. In such a case, the data management section 45 may analyze morphemes of the user data about the place “Bar ∘∘ in Kobe”, thus extracting “Kobe” and “Bar ∘∘” as nouns. The data extraction section 46 may extract the reading information and the grammatical information on the place that are stored in the speech information database 43 based on “Kobe” and “Bar ∘∘”.

### Embodiment 3

Embodiment 2 describes the example where the speech information management device is provided with one speech information database. On the other hand, Embodiment 3 describes an example of a speech information management device provided with a plurality of speech information databases.

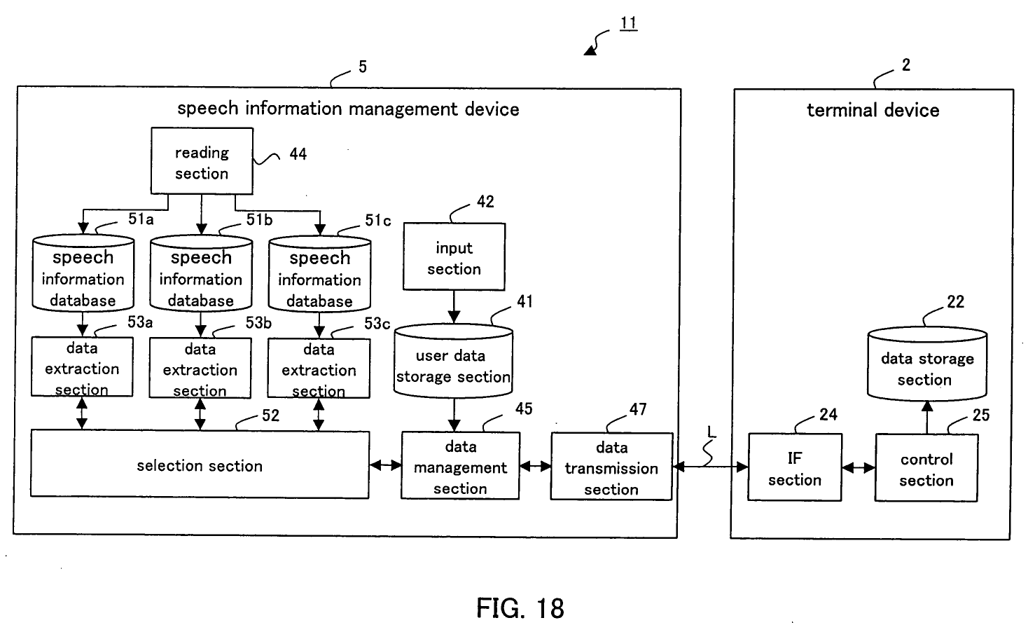

FIG. 18 is a block diagram schematically showing the configuration of a dialogue control system 11 according to the present embodiment. In FIG. 18, the same reference numerals are assigned to the elements having the same functions as in FIG. 10, and their detailed explanations are not repeated.

Namely, the dialogue control system 11 according to the present embodiment includes a speech information management device 5 instead of the speech information management device 4 of FIG. 10. The speech information management device 5 of the present embodiment includes speech information databases 51a to 51c instead of the speech information database 43 of FIG. 10. The speech information management device 5 of the present embodiment further includes a selection section 52 in addition to the speech information management device 4 of FIG. 10. The speech information management device 5 of the present embodiment still further includes data extraction sections 53a to 53c instead of the data extraction section 46 of FIG. 10. Note here that although FIG. 18 shows three speech information databases 51a to 51c for simplifying the description, the number of the speech information databases making up the speech information management device 5 may be any number.

Similarly to the speech information database 43 of FIG. 10, the speech information databases 51a to 51c store reading information including prosodic information of item values of user data and grammatical information indicating one or a plurality of recognition grammars of item values of user data. The speech information databases 51a to 51c are a plurality of databases each having different types of reading information and grammatical information. In the present embodiment, as one example, the speech information database 51a stores reading information and grammatical information on person's names. The speech information database 51b stores reading information and grammatical information on schedule. The speech information database 51c stores reading information and grammatical information on tunes.

The selection section 52 selects one of the speech information databases 51a to 51c from which reading information and grammatical information are to be extracted, based on the type of the user data output from the data management section 45. In the present embodiment, when the type of the user data is a person's name, the selection section 52 selects the speech information database 51a. When the type of the user data is schedule, the selection section 52 selects the speech information database 51b. When the type of the user data is a tune name, the selection section 52 selects the speech information database 51c. When the selection section 52 selects any one of the speech information databases 51a to 51c, the selection section 52 outputs the user data output from the data management section 45 to one of the data extraction sections 53a to 53c that corresponds to the selected speech information data base 51a, 51b or 51c.

As one example, when the user data output from the data management section 45 is “Yamada” and “Taro”, the selection section 52 selects the speech information database 51a in which reading information and grammatical information on person's names are stored. The selection section 52 outputs the user data “Yamada” and “Taro” output from the data management section 45 to the data extraction section 53a corresponding to the selected speech information database 51a.

The data extraction sections 53a to 53c extract the reading information and the grammatical information stored in the speech information databases 51a to 51c, in accordance with item values of the user data output from the selection section 52. The data extraction sections 53a to 53c output the extracted reading information and grammatical information to the selection section 52. The selection section 52 outputs the reading information and grammatical information output from the data extraction sections 53a to 53c to the data management section 45.

Meanwhile, the above-stated speech information management device 5 may be implemented by installing a program in any computer such as a personal computer. That is, the above-stated selection section 52 and data extraction sections 53a to 53c may be embodied by the operation of a CPU of the computer in accordance with a program for implementing their functions. Therefore, the program for implementing the functions of the selection section 52 and the data extraction sections 53a to 53c as well as a recording medium with such a program recorded thereon also are one embodiment of the present invention. The speech information databases 51a to 51c may be embodied by an internal storage device of a computer or a storage device that is accessible from this computer.

As stated above, the dialogue control system 11 of the present embodiment includes a plurality of speech information databases 51a to 51c containing reading information and grammatical information, at least one of which is different in types among the databases. The selection section 52 selects one of the speech information databases 51a to 51c based on the type of the user data extracted by the data management section 45. Thereby, it is possible for the user of the speech information management device 5 to classify the speech information databases 51a to 51c each containing different type of data such as person's names, place names, schedule or tunes, and therefore it is possible to manage the speech information databases 51a to 51c easily.

### Embodiment 4

Embodiment 3 describes the example of the speech information management device provided with a plurality of speech information databases. On the other hand, Embodiment 4 describes an example where a speech information management device is provided with a plurality of speech information databases, and a server device also is provided with a speech information database.

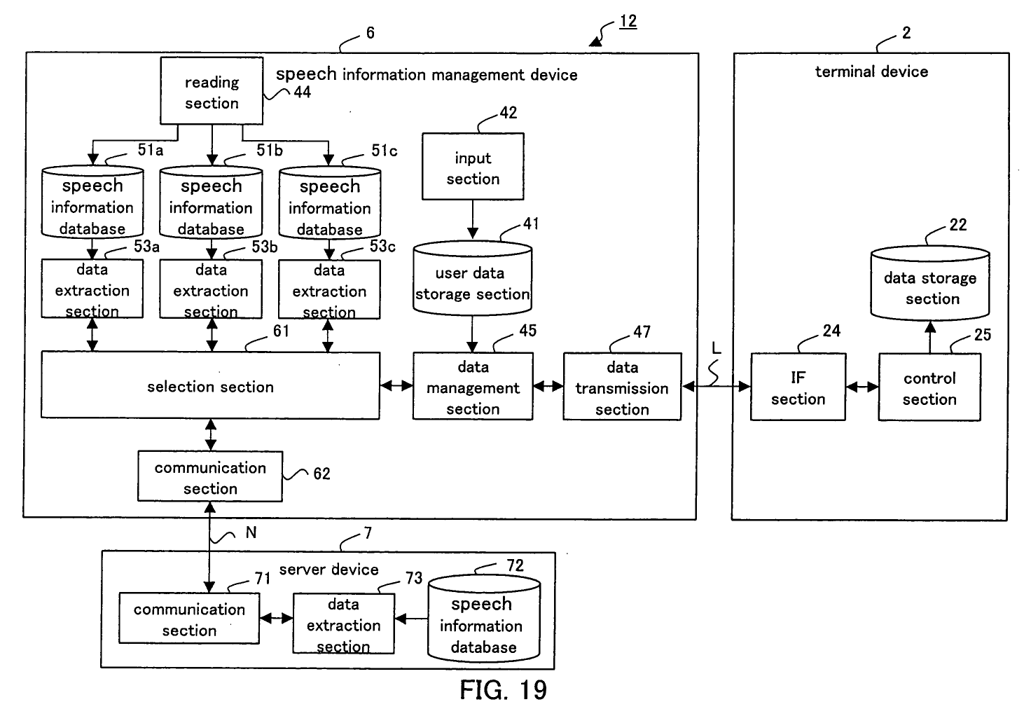

FIG. 19 is a block diagram schematically showing the configuration of a dialogue control system 12 according to the present embodiment. In FIG. 19, the same reference numerals are assigned to the elements having the same functions as in FIG. 18, and their detailed explanations are not repeated.

That is, the dialogue control system 12 according to the present embodiment includes a speech information management device 6 instead of the speech information management device 5 of FIG. 18. The dialogue control system 12 according to the present embodiment further includes a server device 7 in addition to the dialogue control system 11 of FIG. 18. The speech information management device 6 and the server device 7 are connected with each other via the Internet N. Note here that the speech information management device 6 and the server device 7 may be connected with each other by a cable or may be accessible from each other by radio.

The speech information management device 6 according to the present embodiment includes a selection section 61 instead of the selection section 52 of FIG. 18. The speech information management device 6 according to the present embodiment further includes a communication section 62 in addition to the speech information management device 5 of FIG. 18.

The selection section 61 selects one of the speech information databases 51a to 51c and 72 from which reading information and grammatical information are to be extracted, based on the type of the user data output from the data management section 45. When the selection section 61 selects any one of the speech information databases 51a to 51c, the selection section 61 outputs the user data output from the data management section 45 to one of the data extraction sections 53a to 53c that corresponds to the selected speech information data base 51a, 51b or 51c. When the speech information database 72 is selected, the selection section 61 outputs the user data output from the data management section 45 to the communication section 62.

The communication section 62 deals with the communication between the server device 7 and the selection section 61. More specifically, the communication section 62 transmits user data output from the selection section 61 to the server device 7 via the Internet N.

Meanwhile, the above-stated speech information management device 6 may be implemented by installing a program in any computer such as a personal computer. That is, the above-stated selection section 61 and communication section 62 may be embodied by the operation of a CPU of the computer in accordance with a program for implementing their functions. Therefore, the program for implementing the functions of the selection section 61 and the communication section 62 as well as a recording medium with such a program recorded thereon also are one embodiment of the present invention.

The server device 7 includes a communication section 71, a speech information database 72 and a data extraction section 73. The server device 7 may be composed of one or a plurality of computers such as a server, a personal computer and a workstation. In the present embodiment, the server device 7 functions as a Web server. Note here that although FIG. 19 shows one speech information database 72 for simplifying the description, the number of the speech information databases making up the server device 7 may be any number.

The communication section 71 deals with the communication between the speech information management device 6 and the data extraction section 73. More specifically, the communication section 71 transmits user data output from the speech information management device 6 to the data extraction section 73.

Similarly to the speech information databases 51a to 51c, the speech information database 72 stores reading information including prosodic information of item values of user data and grammatical information indicating one or a plurality of recognition grammars of item values of user data. In the present embodiment, as one example, the speech information database 72 stores reading information and grammatical information on place names.

The data extraction section 73 extracts the reading information and grammatical information stored in the speech information database 72 in accordance with user data output from the communication section 71. The data extraction section 73 outputs the extracted reading information and grammatical information to the communication section 71. The communication section 71 transmits the reading information and grammatical information output from the data extraction section 73 to the speech information management device 6 via the Internet N. The communication section 62 outputs the reading information and grammatical information transmitted from the communication section 71 to the selection section 61. The selection section 61 outputs the reading information and grammatical information output from the communication section 62 to the data management section 45.

As stated above, according to the dialogue control system 12 of the present embodiment, the selection section 61 selects the speech information database 72 provided in the server device 7 based on the type of the user data extracted by the data management section 45. Thereby, it is possible for the data management section 45 to associate the user data with at least one of the reading information and the grammatical information stored in the speech information database 72 provided in the server device 7 to generate speech data.

Herein, although Embodiment 1 describes the example of the control device provided with a speech recognition section and a speech synthesis section, the present invention is not limited to this. That is, the control device may be provided with at least one of the speech recognition section and the speech synthesis section.

Further, although Embodiment 2 to Embodiment 4 describe the examples where the speech information databases store reading information and grammatical information, the present invention is not limited to these. That is, the speech information databases may store at least one of the reading information and the grammatical information.

Moreover, Embodiment 1 to Embodiment 4 describe the examples where the data storage section, the user data storage section and the speech information databases store the respective information as entry. However, the present invention is not limited to these. That is, they may be stored in any mode.

As stated above, the present invention is effective as a spoken dialog system, a terminal device, a speech information management device and a recording medium with a program recorded thereon, by which natural synthesized speech can be generated without increasing the cost of the spoken dialog system, and even when utterance is conducted in a plurality of ways, such utterance can be recognized.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A spoken dialog system, comprising:
a communication processing section capable of communicating with a terminal device that stores user data; and
at least one of a speech synthesis section that generates synthesized speech and a speech recognition section that recognizes input speech,
wherein the communication processing section acquires from the terminal device at least one information of reading information and grammatical information, the reading information containing prosodic information on an item value of at least one item of the user data and the grammatical information indicating one or a plurality of recognition grammars on an item value of at least one item of the user data,
the speech synthesis section generates the synthesized speech using the reading information acquired by the communication processing section, and
the speech recognition section recognizes the input speech using the grammatical information acquired by the communication processing section.

2. A terminal device, comprising:
an interface section capable of communicating with a spoken dialog system having at least one function of a function to generate synthesized speech and a function to recognize input speech; and
a data storage section that stores user data,
wherein the data storage section further stores at least one information of reading information and grammatical information, the reading information containing prosodic information on an item value of at least one item of the user data and being used for generating the synthesized speech, and the grammatical information indicating one or a plurality of recognition grammars on an item value of at least one item of the user data and being used for recognizing the input speech,
wherein the terminal device further comprises a control section that detects an event of the terminal device or an event from the spoken dialog system and extracts at least one information of the reading information and the grammatical information stored in the data storage section based on the detected event, and
the interface section transmits the at least one information of the reading information and the grammatical information extracted by the control section to the spoken dialog system.

3. A dialogue control system comprising: a terminal device including a data storage section that stores user data; and a spoken dialog system including at least one of a speech synthesis section that generates synthesized speech and a speech recognition section that recognizes input speech, the terminal device being capable of communicating with the spoken dialog system,
wherein the data storage section further stores at least one information of reading information and grammatical information, the reading information containing prosodic information on an item value of at least one item of the user data and being used for generating the synthesized speech, and the grammatical information indicating one or a plurality of recognition grammars on an item value of at least one item of the user data and being used for recognizing the input speech,
wherein the terminal device further comprises:
a control section that detects an event of the terminal device or an event from the spoken dialog system and extracts at least one information of the reading information and the grammatical information stored in the data storage section based on the detected event, and
an interface section that transmits the at least one information of the reading information and the grammatical information extracted by the control section to the spoken dialog system,
wherein the spoken dialog system further comprises:
a communication processing section that acquires the at least one information of the reading information and the grammatical information transmitted by the interface section,
wherein the speech synthesis section generates the synthesized speech using the reading information acquired by the communication processing section, and
the speech recognition section recognizes the input speech using the grammatical information acquired by the communication processing section.

4. A speech information management device comprising a data transmission section capable of communicating with a terminal device, the speech information management device further comprising:
a data management section that detects an event of the speech information management device or an event from the terminal device and extracts user data from a user data storage section provided in the speech information management device or the terminal device based on the detected event;
a speech information database that stores at least one information of reading information and grammatical information, the reading information containing prosodic information on an item value of the user data and being used for generating synthesized speech and the grammatical information indicating one or a plurality of recognition grammars on an item value of the user data and being used for recognizing input speech; and
a data extraction section that extracts at least one information of the reading information and the grammatical information stored in the speech information database based on an item value of the user data extracted by the data management section,
wherein the data management section associates the item value of the user data with the at least one information of the reading information and the grammatical information extracted by the data extraction section to generate speech data, and
the data transmission section transmits the speech data generated by the data management section to the terminal device.

5. The speech information management device according to claim 4, wherein the data extraction section extracts at least one information of reading information and grammatical information on a place stored in the speech information database based on an item value of address of the user data.

6. The speech information management device according to claim 4, wherein the data extraction section extracts at least one information of reading information and grammatical information on a place stored in the speech information database based on item values of latitude and longitude of the user data.

7. The speech information management device according to claim 4, further comprising:
a plurality of speech information databases, each containing the reading information and the grammatical information, at least one of which is different in type of information among the plurality of speech information databases; and
a selection section that selects one of the plurality of speech information databases based on a type of the user data extracted by the data management section.

8. The speech information management device according to claim 7, further comprising a communication section capable of communicating with a server device,
wherein the server device comprises a speech information database that stores at least one information of the reading information and the grammatical information, and
the selection section selects the speech information database provided in the server device based on a type of the user data extracted by the data management section.

9. A recording medium having stored thereon a program that makes a computer execute the following steps of:
a communication step enabling communication with a terminal device that stores user data; and
at least one of a speech synthesis step of generating synthesized speech; and a speech recognition step of recognizing input speech,
wherein the communication step makes the computer execute a step of acquiring at least one information of reading information and grammatical information, the reading information containing prosodic information on an item value of at least one item of the user data and the grammatical information indicating one or a plurality of recognition grammars on an item value of at least one item of the user data,
the speech synthesis step makes the computer execute the step of generating the synthesized speech using the reading information acquired in the communication step, and
the speech recognition step makes the computer execute the step of recognizing the input speech using the grammatical information acquired in the communication step.

10. A recording medium having stored thereon a program that makes a computer provided with a data storage section that stores user data execute an interface step enabling communication with a spoken dialog system having at least one function of a function to generate synthesized speech and a function to recognize input speech,
wherein the computer is accessible to the data storage section that further stores at least one information of reading information and grammatical information, the reading information containing prosodic information on an item value of at least one item of the user data and being used for generating the synthesized speech, and the grammatical information indicating one or a plurality of recognition grammars on an item value of at least one item of the user data and being used for recognizing the input speech,
wherein the program further makes the computer execute a control step of detecting an event of the computer or an event from the spoken dialog system and extracting at least one information of the reading information and the grammatical information stored in the data storage section based on the detected event, and
the interface step further makes the computer execute a step of transmitting the at least one of the reading information and the grammatical information extracted in the control step to the spoken dialog system.

11. A recording medium having stored thereon a program that makes a computer execute a data transmission step enabling communication with a terminal device, the computer being provided with a speech information database that stores at least one information of reading information and grammatical information, the reading information containing prosodic information on an item value of user data and being used for generating synthesized speech, and the grammatical information indicating one or a plurality of recognition grammars on an item value of the user data and being used for recognizing input speech,
wherein the program further makes the computer execute the following steps of:
a data management step of detecting an event of the computer or an event from the terminal device and extracting user data from a user data storage section provided in the computer or the terminal device based on the detected event; and
a data extraction step of extracting at least one information of the reading information and the grammatical information stored in the speech information database based on an item value of the user data extracted in the data management step,
wherein the data management step makes the computer execute a step of associating the item value of the user data with the at least one information of the reading information and the grammatical information extracted in the data extraction step to generate speech data, and
the data transmission step further makes the computer execute a step of transmitting the speech data generated in the data management step to the terminal device.
